(19) United States
(12) Patent Application Publication
(10) Pub. No.: US 2010/0005218 A1
(43) Pub. Date: Jan. 7, 2010

(54) ENHANCED CASCADE INTERCONNECTED MEMORY SYSTEM

(75) Inventors: Kevin C. Gower, LaGrangeville, NY (US); Paul W. Coteus, Yorktown Heights, NY (US); Warren E. Maule, Cedar Park, TX (US); Robert B. Tremaine, Stormville, NY (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/165,816

(22) Filed: Jul. 1, 2008

(51) Int. Cl. G06F 12/06

(52) U.S. Cl. 711/5; 711/E12.082

(57) ABSTRACT

A system, memory hub device, method and design structure for providing an enhanced cascade interconnected memory system are provided. The system includes a memory controller, a memory channel, a memory hub device coupled to the memory channel to communicate with the memory controller via one of a direct connection and a cascade interconnection through another memory hub device, and multiple memory devices in communication with the memory controller via one or more cascade interconnected memory hub devices. The memory channel includes unidirectional downstream link segments coupled to the memory controller and operable for transferring configurable data frames. The memory channel further includes unidirectional upstream link segments coupled to the memory controller and operable for transferring data frames.

This invention was made with Government support under Agreement No. HR0011-07-9-002 awarded by DARPA. The Government has certain rights in the invention.

### BACKGROUND

This invention relates generally to computer memory systems, and more particularly to an enhanced cascade interconnected memory system.

Contemporary high performance computing main memory systems are generally composed of one or more dynamic random access memory (DRAM) devices, which are connected to one or more processors via one or more memory control elements. Overall computer system performance is affected by each of the key elements of the computer structure, including the performance/structure of the processor(s), any memory cache(s), the input/output (I/O) subsystem(s), the efficiency of the memory control function(s), the main memory device(s), and the type and structure of the memory interconnect interface(s).

Extensive research and development efforts are invested by the industry, on an ongoing basis, to create improved and/or innovative solutions to maximizing overall system performance and density by improving the memory system/subsystem design and/or structure. High-availability systems present further challenges as related to overall system reliability due to customer expectations that new computer systems will markedly surpass existing systems in regard to mean-time-between-failure (MTBF), in addition to offering additional functions, increased performance, increased storage, lower operating costs, etc. Other frequent customer requirements further exacerbate the memory system design challenges, and include such items as ease of upgrade and reduced system environmental impact (such as space, power and cooling).

### SUMMARY

An exemplary embodiment is a system that includes a memory controller, a memory channel, a memory hub device coupled to the memory channel to communicate with the memory controller via one of a direct connection and a cascade interconnection through another memory hub device, and multiple memory devices in communication with the memory controller via one or more cascade interconnected memory hub devices. The memory channel includes unidirectional downstream link segments including at least 13 data bit lanes, 2 spare bit lanes and a downstream clock coupled to the memory controller and operable for transferring data frames configurable between 8, 12 and 16 transfers per frame, with each transfer including multiple bit lanes. The memory channel further includes unidirectional upstream link segments including at least 20 bit lanes, 2 spare bit lanes and an upstream clock coupled to the memory controller and operable for transferring data frames including 8 transfers per frame, with each transfer including of multiple bit lanes.

Another exemplary embodiment is a memory hub device that includes a link interface to communicate to one or more of a memory controller and another memory hub device via a memory channel. The memory channel includes unidirectional downstream link segments including at least 13 data bit lanes, 2 spare bit lanes and a downstream clock, coupled to the memory controller and operable for transferring data frames configurable between 8, 12 and 16 transfers per frame, with each transfer including multiple bit lanes. The memory channel also includes unidirectional upstream link segments including at least 20 bit lanes, 2 spare bit lanes and an upstream clock, coupled to the memory controller and operable for transferring data frames including 8 transfers per frame, with each transfer including multiple bit lanes. The memory hub device further includes a plurality of ports, where each port is configured to communicate to one of a memory device and a register device. The register device includes address, command and control re-drive circuitry and clock re-alignment and re-drive circuitry to control access to one or more memory devices.

A further exemplary embodiment is a method for providing an enhanced cascade interconnected memory system. The method includes configuring a memory hub device to communicate with a memory controller and multiple memory devices, where communication between the memory hub and the memory controller is established via a memory channel. The memory channel includes unidirectional downstream link segments including at least 13 data bit lanes, 2 spare bit lanes and a downstream clock coupled to the memory controller and operable for transferring data frames configurable between 8, 12 and 16 transfers per frame, with each transfer including multiple bit lanes. The memory channel further includes unidirectional upstream link segments including at least 20 bit lanes, 2 spare bit lanes and an upstream clock coupled to the memory controller and operable for transferring data frames including 8 transfers per frame, with each transfer including multiple bit lanes. The method further includes configuring primary and secondary upstream and downstream transmitters and receivers of the memory hub device to communicate with the memory controller via the memory channel and one or more cascade interconnected memory hub devices.

An additional exemplary embodiment is a design structure tangibly embodied in a machine-readable medium for designing, manufacturing, or testing an integrated circuit. The design structure includes a link interface to communicate to one or more of a memory controller and another memory hub device via a memory channel. The memory channel includes unidirectional downstream link segments including at least 13 data bit lanes, 2 spare bit lanes and a downstream clock, coupled to the memory controller and operable for transferring data frames configurable between 8, 12 and 16 transfers per frame, with each transfer including multiple bit lanes. The memory channel also includes unidirectional upstream link segments including at least 20 bit lanes, 2 spare bit lanes and an upstream clock, coupled to the memory controller and operable for transferring data frames including 8 transfers per frame, with each transfer including multiple bit lanes. The design structure further includes a plurality of ports, where each port is configured to communicate to one of a memory device and a register device. The register device includes address, command and control re-drive circuitry and clock re-alignment and re-drive circuitry to control access to one or more memory devices.

Other systems, methods, apparatuses, design structures and/or computer program products according to embodiments will be or become apparent to one with skill in the art upon review of the following drawings and detailed description. It is intended that all such additional systems, methods, apparatuses, design structures and/or computer program products be included within this description, be within the scope of the present invention, and be protected by the accompanying claims.

### BRIEF DESCRIPTION OF THE SEVERAL VIEWS OF THE DRAWINGS

Referring now to the drawings wherein like elements are numbered alike in the several FIGURES:

FIG. 1 depicts a memory system interfacing with multiple registered dual in-line memory modules (RDIMMs) communicating via high-speed upstream and downstream links that may be implemented by exemplary embodiments;

FIG. 2 depicts cascade interconnected communication interface devices via high-speed upstream and downstream links that may be implemented by exemplary embodiments;

FIG. 3 depicts an example of cascaded clocking in a cascade interconnected memory system that may be implemented by exemplary embodiments;

FIG. 4 depicts clock ratio adjustment logic that may be implemented by exemplary embodiments;

FIG. 5 depicts a cascade interconnected memory system that includes fully buffered DIMMs communicating via high-speed upstream and downstream links that may be implemented by exemplary embodiments;

FIG. 6 depicts a memory hub device coupled with multiple ranks of memory devices that may be implemented by exemplary embodiments;

FIG. 7 depicts functional blocks of a memory hub device that may be implemented by exemplary embodiments;

FIG. 8 depicts an example of multiple memory hub devices, each with two ports interfaced to two RDIMMs per port;

FIG. 9 depicts an example of multiple memory hub devices, each with two ports interfaced to one RDIMM per port;

FIG. 10 depicts an example of a memory hub device with two ports interfaced to multiple DDR3 x8 memory devices;

FIG. 11 depicts an example of a memory hub device with two ports interfaced to multiple DDR3 x4 memory devices;

FIG. 12 depicts an example of a memory hub device with two ports each interfaced to two ranks of DDR3 x4 memory devices via a register;

FIG. 13 depicts an example of a memory hub device with two ports each interfaced to two ranks of DDR3 x4 memory devices via two registers;

FIG. 14 depicts an exemplary process for providing an enhanced cascade interconnected memory system that may be implemented by exemplary embodiments; and

FIG. 15 is a flow diagram of a design process used in semiconductor design, manufacture, and/or test.

### DETAILED DESCRIPTION

The invention as described herein provides an enhanced cascade interconnected memory system. Interposing a memory hub device as a communication interface device between a memory controller and memory devices enables a flexible high-speed protocol with error detection to be implemented. The enhanced cascade interconnected memory system enables low latency, deterministic read data return and downstream channel command and data packing that leverage available memory channel bandwidth. The enhanced cascade interconnected memory system also provides improved reliability/availability/serviceability (RAS), memory density and power management capability enabling high value server computing systems. In an exemplary embodiment, efficiency gains are achieved by intermixing of command and data streams instead of a fixed bandwidth allocation between commands and data. The protocol allows a high-speed memory channel to operate at a fixed frequency, which is a variable multiple of the memory device clock frequency. Flexibility is increased using variable frame formats to maximize utilization of available communication bandwidth at a selected ratio between the high-speed bus and memory device clock frequencies. Buffering of read data may enable read commands to be issued while the communication channel returning read data is busy to avoid the need for precise scheduling and minimize wasted bandwidth. Further flexibility is provided with multiple ports that are configurable to interface directly with one or more ranks of memory devices and registers of industry-standard registered dual in-line memory modules (RDIMMs). Additional features are described in greater detail herein.

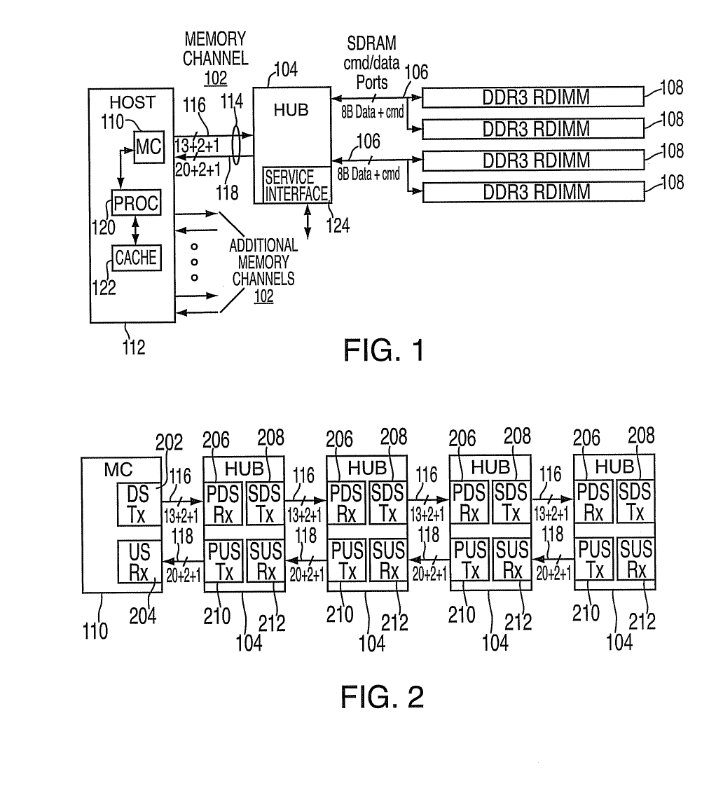

Turning now to FIG. 1, an example of a memory system 100 that includes one or more host memory channels 102 each connected to one or more cascaded memory hub devices 104 is depicted in a planar configuration. Each memory hub device 104 may include two synchronous dynamic random access memory (SDRAM) ports 106 connected to zero, one or two industry-standard RDIMMs 108. For example, the RDIMMs 108 can utilize multiple memory devices, such as a version of double data rate (DDR) dynamic random access memory (DRAM), e.g., DDR1, DDR2, DDR3, DDR4, etc. Although the example depicted in FIG. 1 utilizes DDR3 for the RDIMMs 108, other memory device technologies may also be employed within the scope of the invention. The memory channel 102 carries information to and from a memory controller 110 in host processing system 112. The memory channel 102 may transfer data at rates upwards of 6.4 Gigabits per second. The memory hub device 104 translates the information from a high-speed reduced pin count bus 114 which enables communication to and from the memory controller 110 of the host processing system 112 to lower speed, wide, bidirectional ports 106 to support low-cost industry standard memory, thus the memory hub device 104 and the memory controller 110 are both generically referred to as communication interface devices. The bus 114 includes downstream link segments 116 and upstream link segments 118 as unidirectional links between devices in communication over the bus 114. The term “downstream” indicates that the data is moving from the host processing system 112 to the memory devices of the RDIMMs 108. The term “upstream” refers to data moving from the memory devices of the RDIMMs 108 to the host processing system 112. The information stream coming from the host processing system 112 can include of a mixture of commands and data to be stored in the RDIMMs 108 and redundancy information, which allows for reliable transfers. The information returning to the host processing system 112 can include data retrieved from the memory devices on the RDIMMs 108, as well as redundant information for reliable transfers. Commands and data can be initiated in the host processing system 112 using processing elements known in the art, such as one or more processors 120 and cache memory 122. The memory hub device 104 can also include additional communication interfaces, for instance, a service interface 124 to initiate special test modes of operation that may assist in configuring and testing the memory hub device 104.

In an exemplary embodiment, the memory controller 110 has a very wide, high bandwidth connection to one or more processing cores of the processor 120 and cache memory 122. This enables the memory controller 110 to monitor both actual and predicted future data requests to the memory channel 102. Based on the current and predicted processor 120 and cache memory 122 activity, the memory controller 110 determines a sequence of commands to best utilize the attached memory resources to service the demands of the processor 120 and cache memory 122. This stream of commands is mixed together with data that is written to the memory devices of the RDIMMs 108 in units called “frames”. The memory hub device 104 interprets the frames as formatted by the memory controller 110 and translates the contents of the frames into a format compatible with the RDIMMs 108.

Although only a single memory channel 102 is depicted in detail in FIG. 1 connecting the memory controller 110 to a single memory device hub 104, systems produced with this configuration may include more than one discrete memory channel 102 from the memory controller 110, with each of the memory channels 102 operated singly (when a single channel is populated with modules) or in parallel (when two or more channels are populated with modules) to achieve the desired system functionality and/or performance. Moreover, any number of lanes can be included in the bus 114, where a lane includes link segments that can span multiple cascaded memory hub devices 104. For example, the downstream link segments 116 can include 13 bit lanes, 2 spare lanes and a clock lane, while the upstream link segments 118 may include 20 bit lanes, 2 spare lanes and a clock lane. To reduce susceptibility to noise and other coupling interference, low-voltage differential-ended signaling may be used for all bit lanes of the bus 114, including one or more differential-ended clocks. Both the memory controller 110 and the memory hub device 104 contain numerous features designed to manage the redundant resources, which can be invoked in the event of hardware failures. For example, multiple spare lanes of the bus 114 can be used to replace one or more failed data or clock lane in the upstream and downstream directions.

In one embodiment, one of the spares can be used to replace either a data or clock link, while a second spare is used to repair a data link but not a clock link. This maximizes the ability to survive multiple interconnect hard failures. Additionally, one or more of the spare lanes can be used to test for transient failures or establish bit error rates. The spare lanes are tested and aligned during initialization but are deactivated during normal run-time operation. The channel frame format, error detection and protocols are the same before and after spare lane invocation. Spare lanes may be selected by any of the following processes:

1. Spare lanes can be selected during initialization by loading configuration registers in the host processing system 112 and the memory hub device 104 based on previously logged lane failure information.
2. Spare lanes can be selected dynamically by hardware during run-time operation by an error recovery operation performing a link re-initialization and repair procedure. This procedure is initiated by the memory controller 110 and supported by the memory hub devices 104 of the associated memory channel. During the link repair operation the memory controller 110 holds back memory access requests. The procedure is designed to take less than a predetermined time, e.g., 10 milliseconds, to prevent system performance issues such as timeouts.
3. Spare lanes can be selected by system control software by loading configuration registers in the host processing system 112 and/or the memory hub device 104 based on results of a memory channel lane shadowing diagnostic procedure.

In order to allow larger memory configurations than could be achieved with the pins available on a single memory hub device 104, the memory channel protocol implemented in the memory system 100 allows for the memory hub devices to be cascaded together. Memory hub device 104 contains buffer elements in the downstream and upstream directions so that the flow of data can be averaged and optimized across the high-speed memory channel 102 to the host processing system 112. Flow control from the memory controller 110 in the downstream direction is handled by downstream transmission logic (DS Tx) 202, while upstream data is received by upstream receive logic (US Rx) 204 as depicted in FIG. 2. The DS Tx 202 drives signals on the downstream segments 116 to a primary downstream receiver (PDS Rx) 206 of memory hub device 104. If the commands or data received at the PDS Rx 206 target a different memory hub device, then it is redriven downstream via a secondary downstream transmitter (SDS Tx) 208; otherwise, the commands and data are processed locally at the targeted memory hub device 104. The memory hub device 104 may analyze the commands being redriven to determine the amount of potential data that will be received on the upstream segments 118 for timing purposes in response to the commands. Similarly, to send responses upstream, the memory hub device 104 drives upstream communication via a primary upstream transmitter (PUS Tx) 210 which may originate locally or be redriven from data received at a secondary upstream receiver (SUS Rx) 212.

A single memory hub device 104 simply receives commands and write data on its primary downstream link, PDS Rx 206, via downstream link segments 116 and returns read data and responses on its primary upstream link, PUS Tx 210, via upstream link segments 118.

Memory hub devices 104 within a cascaded memory channel are responsible for capturing and repeating downstream frames of information received from the host processing system 112 on its primary side onto its secondary downstream drivers to the next cascaded memory hub device 104, an example of which is depicted in FIG. 2. Read data from cascaded memory hub devices 104 downstream of a local memory hub device 104 are safely captured using secondary upstream receivers and merged into a local data stream to be returned safely to the host processing system 112 on the primary upstream drivers.

Memory hub devices 104 include support for a separate out-of-band service interface 124, as depicted in FIG. 1, which can be used for advanced diagnostic and testing purposes. It can be configured to operate either in a double, (redundant) field replaceable unit service interface (FSI) or Joint Test Action Group (JTAG) mode. Power-on reset and initialization of the memory hub devices 104 may rely heavily on the service interface 124. In addition, each memory hub device 104 can include an inter-integrated circuit (I²C or I2C) master interface that can be controlled through the service interface 124. The I²C master enables communications to any I²C slave devices connected to I²C pins on the memory hub devices 104 through the service interface 124.

The memory hub devices 104 have a unique identity assigned to them in order to be properly addressed by the host processing system 112 and other system logic. The chip ID field can be loaded into each memory hub device 104 during its configuration phase through the service interface 124.

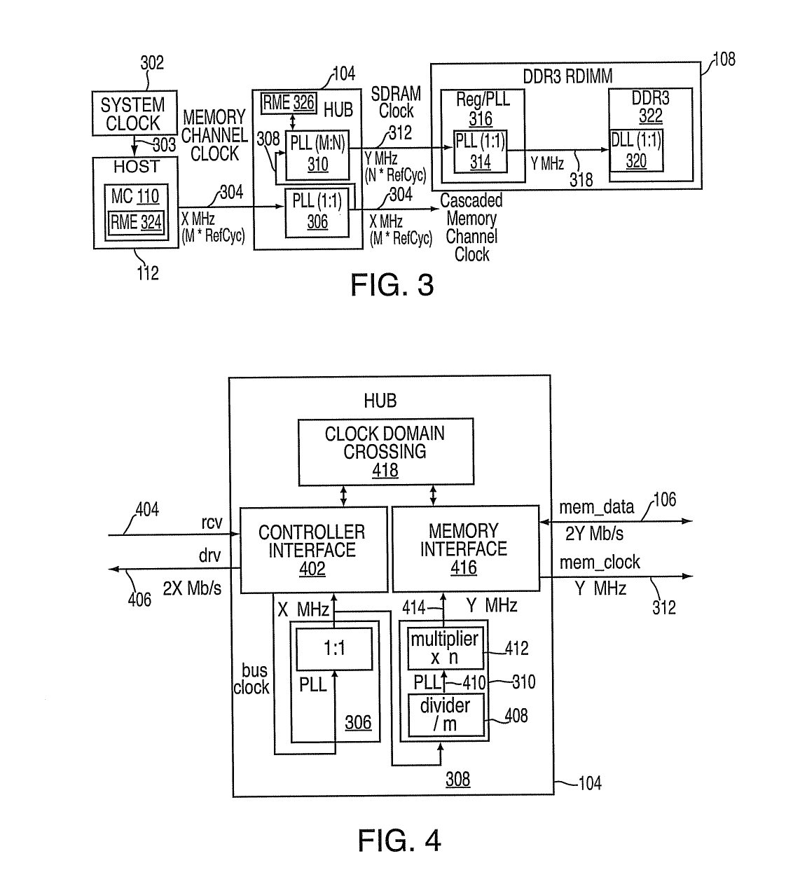

The memory system 100 uses cascaded clocking to send clocks between the memory controller 110 and memory hub devices 104, as well as to the memory devices of the RDIMMs 108. An example clock configuration is depicted in FIG. 3. The host processing system 112 receives its clock 303 distributed from system clock 302. The clock 303 is forwarded to the memory hub device 104 as bus clock 304 operating at a high-speed bus clock frequency on the downstream segments 116 of the bus 114. The memory hub device 104 uses a phase locked loop (PLL) 306 to clean up the bus clock 304, which is passed to configurable PLL 310 (i.e., clock ratio logic) as hub clock 308 and forwarded as bus clock 304 to the next downstream memory hub device 104. The output of the configurable PLL 310 is SDRAM clock 312 (i.e., memory bus clock) operating at a memory bus clock frequency, which is a scaled ratio of the bus clock 304. PLL 314 further conditions the SDRAM clock 312 locally in register/PLL logic 316 of RDIMM 108, producing memory device clock 318. A delay-locked loop (DLL) 320 maintains any phase shift of the memory device clock 318 in a fixed location across process, voltage, and temperature variations in the memory device 322. The memory controller 110 and the memory hub device 104 also include ratio modulus engines (RMEs) 324 and 326 respectively to synchronize communication. The RMEs 324 and 326 can be synchronized during initialization of the memory channel 102 and increment in lockstep based on the amount of data transmitted via the bus 114.

Commands and data values communicated on the bus 114 may be formatted as frames and serialized for transmission at a high data rate, e.g., stepped up in data rate by a factor of 4, 5, 6, 8, etc.; thus, transmission of commands, address and data values is also generically referred to as “data” or “high-speed data” for transfers on the bus 114 (also referred to as high-speed bus 114). In contrast, memory bus communication is also referred to as “lower-speed”, since the memory bus clock 312 of FIG. 3 operates as a reduced ratio of the bus clock 304 (also referred to as high-speed clock 304). In order to support multiple clock ratios, frames are further divided into units called “blocks”. The number of transfers in a downstream frame is a function of the configurable memory channel to SDRAM clock ratio (M:N) as programmed in the configurable PLL 310.

In an exemplary embodiment, the RME 326 of FIG. 3 generates a sequence of identifiers used by the memory controller hub 104 to determine which blocks the memory controller 110 has sent on each memory clock cycle. Thus, a variety of standard memory speeds can be supported using different clock ratios and frame sequencing as depicted in table 1. The frame sequence indicates a number of transfers per frame, where the number can alternate from frame to frame in order to maintain a desired clock ratio. In an exemplary embodiment, downstream data frames are configurable between 8, 12 and 16 transfers per frame, while upstream data frames are 8 transfers per frame, with each transfer including multiple bit lanes.

TABLE 1
Example Clock Ratios and Frame Sequences

| | | | |
|---|---|---|---|
| Memory Channel | DRAM Data | Clock | |
| Rate | Rate | Ratio | Frame Sequence |

| | | | | | |
|---|---|---|---|---|---|
| 6.4 | GHz | 1600 | MHz | 4:1 | 8, 8, . . . |
| 6.667 | GHz | 1333 | MHz | 5:1 | 8, 12, 8, 12, . . . |
| 6.4 | GHz | 1280 | MHz | 5:1 | 8, 12, 8, 12, . . . |
| 6.4 | GHz | 1067 | MHz | 6:1 | 12, 12, . . . |
| 6.4 | GHz | 800 | MHz | 8:1 | 16, 16, . . . |
| 5.333 | GHz | 1333 | MHz | 4:1 | 8, 8, . . . |
| 5.333 | GHz | 1067 | MHz | 5:1 | 8, 12, 8, 12, . . . |
| 5.333 | GHz | 889 | MHz | 6:1 | 12, 12, . . . |
| 5.333 | GHz | 667 | MHz | 8:1 | 16, 16, . . . |
| 4.8 | GHz | 1200 | MHz | 4:1 | 8, 8, . . . |
| 4.8 | GHz | 960 | MHz | 5:1 | 8, 12, 8, 12, . . . |
| 4.8 | GHz | 800 | MHz | 6:1 | 12, 12, . . . |
| 4.8 | GHz | 600 | MHz | 8:1 | 16, 16, . . . |

FIG. 4 provides additional details of the configurable clock ratio logic in the memory hub device 104. A controller interface 402 receives and drives data on links 404 and 406, which may be either downstream link segments 116 or upstream link segments 118. The hub clock 308 that is output from the PLL 306 may be used to establish a clock domain for the controller interface 402. The configurable PLL 310 is used to divide the hub clock 308 by a configurable integer (M) using frequency divider 408 to create a lower frequency base clock 410. The base clock 410 is then multiplied by a separately configurable integer (N) using frequency multiplier 412 to create a clock domain 414 for memory interface 416. This enables an M:N non-integer clock domain ratio by using the two separately configurable integers, M and N. Clock domain crossing logic 418 may be used to communicate between the separate clock domains of the controller interface 402 and the memory interface 416. The memory interface 416 sends memory commands and data on SDRAM port 106 and a memory clock on SDRAM clock 312. Adjusting values in the frequency divider 408 and the frequency multiplier 412 allows different clock ratios to be supported in the memory system 100.

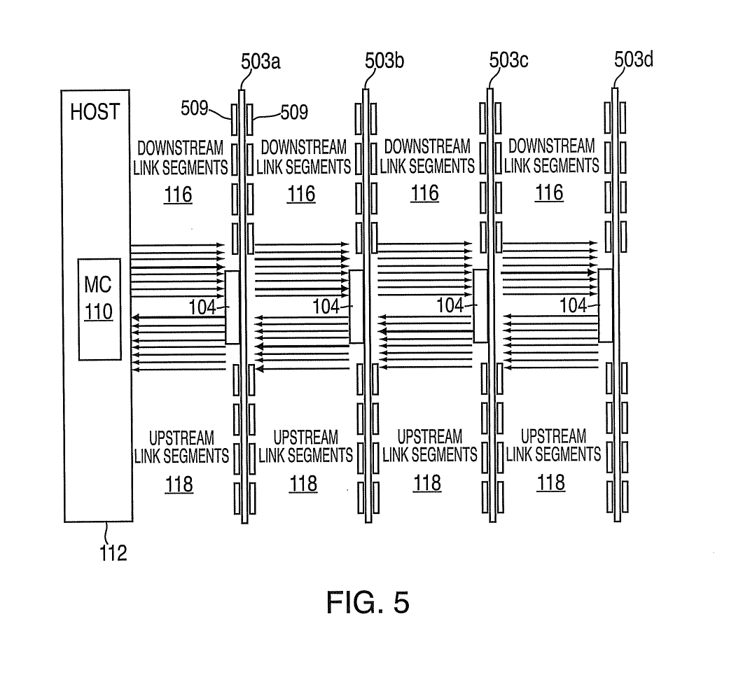

FIG. 5 depicts an exemplary embodiment where the memory hub devices 104 are integrated on DIMMs 503a, 503b, 503c, and 503d communicating via cascade interconnected downstream link segments 116 and upstream link segments 118. The DIMMs 503a-503d can include multiple memory devices 509, which may be DDR DRAM devices, as well as other components known in the art, e.g., resistors, capacitors, etc. The memory devices 509 are also referred to as DRAM 509 or DDRx 509, as any version of DDR may be included on the DIMMs 503a-503d, e.g., DDR2, DDR3, DDR4, etc. It can also be seen in FIG. 5 that the DIMM 503a, as well as DIMMs 503b-d may be dual sided, having memory devices 509 on both sides of the modules. Memory controller 110 in host 112 interfaces with DIMM 503a, sending commands, address and data values via the downstream link segments 116 and upstream link segments 118 that may target any of the DIMMs 503a-503d. If a DIMM receives a command that is not intended for it, the DIMM redrives the command to the next DIMM in the daisy chain (e.g., DIMM 503a redrives to DIMM 503b, DIMM 503b redrives to DIMM 503c, etc.).

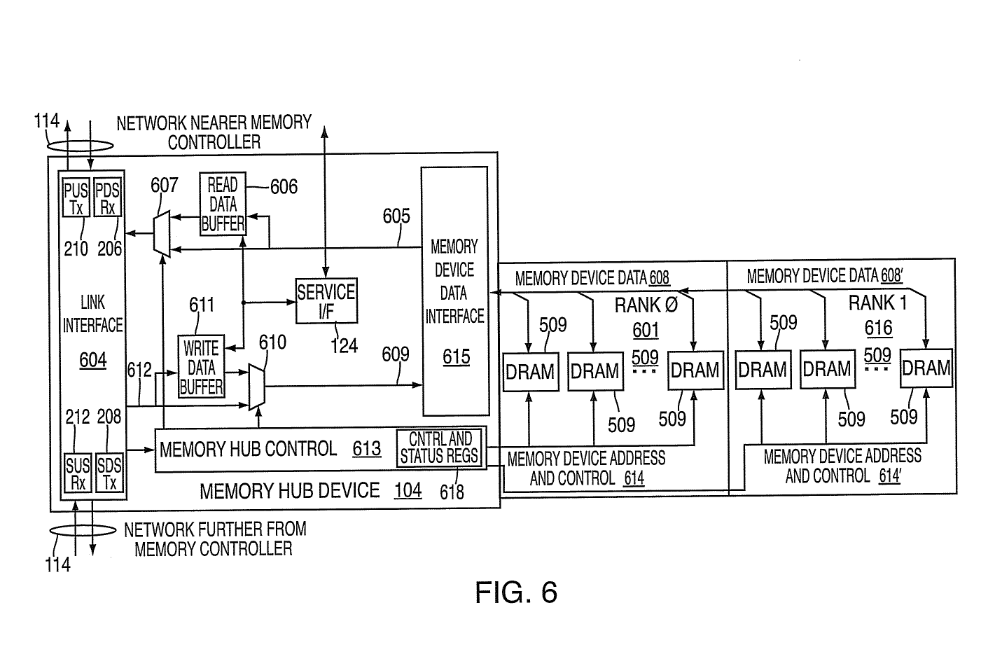

The memory devices 509 may be organized as multiple ranks as shown in FIG. 6. Link interface 604 provides means to re-synchronize, translate and re-drive high speed memory access information to associated DRAM devices 509 and/or to re-drive the information downstream on memory bus 114 as applicable based on the memory system protocol. The memory hub device 104 supports multiple ranks (e.g., rank 0 601 and rank 1 616) of DRAM 509 as separate groupings of memory devices using a common hub. The link interface 604 can include PDS Rx 206, SDS Tx 208, PUS Tx 210, and SUS Rx 212 for FIG. 2 as a subset of the controller interface 402 of FIG. 4. to support driving, receiving, sparing, and repair of link segments in upstream and downstream directions on memory bus 114. Data and clock link segments are received by the link interface 604 from an upstream memory hub device 104 or from memory controller 110 (directly or via an upstream memory hub device 104) via the memory bus 114.

Memory device data interface 615 manages a technology-specific data interface with the memory devices 509 and controls bi-directional memory data bus 608 and may be a subset of the memory interface 416 of FIG. 4. In an exemplary embodiment, the memory device data interface 615 supports both 1T and 2T addressing modes that hold memory command signals valid for one or two memory clock cycles and delays memory chip select signals as needed. The 2T addressing mode may be used for memory command busses that are so heavily loaded that they cannot meet DRAM timing requirements for command/address setup and hold.

The memory hub control 613 responds to access request frames by responsively driving the memory device technology-specific address and control bus 614 (for memory devices in rank 0 601) or address and control bus 614′ (for memory devices in rank 1 616) and directing read data flow 607 and write data flow 610 selectors. The link interface 604 decodes the frames and directs the address and command information directed to the memory hub device 104 to the memory hub control 613. The memory hub control 613 may include control and status registers 618 to control memory access at the device level and the rank level, as well as one or more fault indicators. Memory write data from the link interface 604 can be temporarily stored in the write data buffer 611 or directly driven to the memory devices 609 via the write data flow selector 610 and internal bus 612, and then sent via internal bus 609 and memory device data interface 615 to memory device data bus 608. Memory read data from memory device(s) 509 can be queued in the read data buffer 606 or directly transferred to the link interface 604 via internal bus 605 and read data selector 607, to be transmitted on upstream link segments of the bus 114 as a read data frame or upstream frame. In an exemplary embodiment, the read data buffer 606 is 4×72-bits wide x8 transfers deep, and the write data buffer 611 is 16×72-bits wide x8 transfers deep (8 per port 106). The read data buffer 606 and the write data buffer 611 can be further partitioned on a port basis, such as separate buffers for each of the ports 106. The read data buffer 606 and the write data buffer 611 may also be accessed via the service interface 124 of FIG. 1. Additional buffering (not depicted) can be included in the memory hub device 104, e.g., in the link interface 604. Service interface 124 can be used as an independent means to access the read data buffer 606 (read) and the write data buffer 611 (read/write) prior to configuring the link interface 604.

Read data buffers 606 and read data delays are used to prevent collisions between local read data and read data from cascaded memory hub devices 104. In an exemplary embodiment, every memory hub device 104 in a cascaded channel decodes all memory read operations. Both the host processing system 112 and the memory hub devices 104 track the return time of the most recent read operation. When a new read command is issued a deterministic amount of delay can be added to the return time based on the configured latencies of the memory hub devices 104 and the last outstanding return time. Data delay can be used to determine how many cycles to store read data in the read data buffers. When a read data buffer timer expires, the memory hub device 104 transmits the read data to the host through the PUS Tx 210. This delay calculation and buffer technique ensures that each read data request is granted a collision-free time slot on an upstream channel.

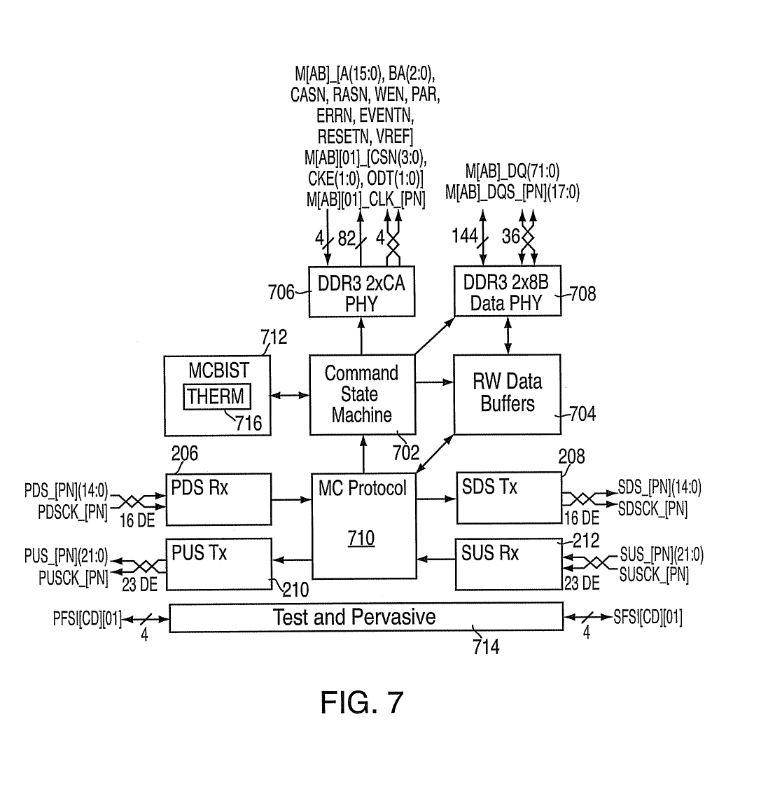

FIG. 7 depicts a block diagram of an embodiment of memory hub device 104 that includes a command state machine 702 coupled to read/write (RW) data buffers 704, a DDR3 command and address physical interface supporting two ports (DDR3 2xCA PHY) 706, a DDR3 data physical interface supporting two 8-byte ports (DDR3 2x8B Data PHY) 708, a memory control (MC) protocol block 710, and a memory card built-in self test engine (MCBIST) 712. The MCBIST 712 provides the capability to read/write different types of data patterns to specified memory locations for the purpose of detecting DIMM/DRAM faults that are common in memory subsystems. The command state machine 702 translates and interprets commands received from the MC protocol block 710 and the MCBIST 712 and may perform functions as previously described in reference to the controller interface 402 of FIG. 4 and the memory hub control 613 of FIG. 6. The RW data buffers 704 represents a combination of the read data buffer 606 and the write data buffer 611 of FIG. 6. The MC protocol block 710 interfaces to PDS Rx 206, SDS Tx 208, PUS Tx 210, and SUS Rx 212, with the functionality as previously described in reference to FIGS. 2 and 6. The MC protocol block 710 also interfaces with the RW data buffers 704. Additionally, a test and pervasive block 714 interfaces with primary FSI clock and data (PFSI[CD][01]) and secondary (daisy chained) FSI clock and data (SFSI[CD][01]) as an embodiment of the service interface 124 of FIG. 1. A thermal monitor 716 can be coupled to various test functions, such as MCBIST 712, test and pervasive block 714, or physical interfaces such as DDR3 2xCA PHY 706.

Inputs to the PDS Rx 206 include true and compliment primary downstream link signals (PDS_[PN](14:0)) and clock signals (PDSCK_[PN]). Outputs of the SDS Tx 208 include true and compliment secondary downstream link signals (SDS_[PN](14:0)) and clock signals (SDSCK_[PN]). Outputs of the PUS Tx 210 include true and compliment primary upstream link signals (SUS_[PN](21:0)) and clock signals (SUSCK_[PN]). Inputs to the SUS Rx 212 include true and compliment secondary upstream link signals (PUS_[PN](21:0)) and clock signals (SUSCK_[PN]).

The DDR3 2xCA PHY 706 and the DDR3 2x8B Data PHY 708 provide command, address and data physical interfaces for DDR3 for 2 ports. The DDR3 2xCA PHY 706 includes memory port A and B address/command signals (M[AB]_[A(15:0),BA(2:0), CASN,RASN,RESETN,WLN,PAR,ERRN,EVENTN]), memory IO DQ voltage reference (M[AB][01]_VREF), memory DIMM A0, A1, B0, B1 control signals (M[AB][01]_[CSN(3:0),CKE(1:0),ODT(1:0)]), and memory DIMM A0, A1, B0, B1 clock differential signals (M[AB][01]_CLK_[PN]). The DDR3 2x8B Data PHY 708 includes memory port A and B data query signals (M[AB]_DQ(71:0)) and memory port A and B data query strobe differential signals (M[AB]_DQS_[PN](17:0)).

To support a variety of memories, such as DDR, DDR2, DDR3, DDR3+, DDR4, and the like, the memory hub device 104 may output one or more variable voltage rails and reference voltages that are compatible with each type of memory device, e.g., M[AB][01]_VREF. Calibration resistors can be used to set variable driver impedance, slew rate and termination resistance for interfacing between the memory hub device 104 and memory devices.

In an exemplary embodiment, the memory hub device 104 uses scrambled data patterns to achieve transition density to maintain a bit-lock. Bits are switching pseudo-randomly, whereby ‘1’ to ‘0’ and ‘0’ to ‘1’ transitions are provided even during extended idle times on a memory channel, e.g., memory channel 102. The scrambling patterns may be generated using a 23-bit pseudo-random bit sequencer. The scrambled sequence can be used as part of a link training sequence to establish and configure communication between the memory controller 110 and one or more memory hub devices 104.

In an exemplary embodiment, the memory hub device 104 provides a variety of power saving features. The command state machine 702 and/or the test and pervasive block 714 can receive and respond to clocking configuration commands that may program clock domains within the memory hub device 104 or clocks driven externally via the DDR3 2xCA PHY 706. Static power reduction is achieved by programming clock domains to turn off, or doze, when they are not needed. Power saving configurations can be stored in initialization files, which may be held in non-volatile memory. Dynamic power reduction is achieved using clock gating logic distributed within the memory hub device 104. When the memory hub device 104 detects that clocks are not needed within a gated domain, they are turned off. In an exemplary embodiment, clock gating logic that knows when a clock domain can be safely turned off is the same logic decoding commands and performing work associated with individual macros. For example, a configuration register inside of the command state machine 702 constantly monitors command decodes for a configuration register load command. On cycles when the decode is not present, the configuration register may shut off the clocks to its data latches, thereby saving power. Only the decode portion of the macro circuitry runs all the time and controls the clock gating of the other macro circuitry.

Examples of different clock domains are depicted in FIG. 4, although it will be understood that additional domains may exist, such as between the command state machine 702 and the test and pervasive block 714. Dynamic clock gating can be used to achieve idle power specifications. If the memory controller 110 of FIG. 1 reduces, or throttles, memory commands, the memory hub device 104 power may also be reduced. Both static and dynamic clock gating allow power savings without additional memory latency penalties. The memory hub device 104 and memory devices 509 may enable the memory controller 110 to dynamically place the memory devices 509 into ‘power down’ mode. This mode can significantly reduce memory device power dissipation with little to no performance impact.

The memory hub device 104 may be configured in multiple low power operation modes. For example, low power mode 1 (LP1) gates off many running clock domains memory hub device 104 to reduce power. Before entering LP1, the memory controller 110 can command that the memory devices 509 be placed into self refresh mode. The memory hub device 104 shuts off the memory device clocks (e.g., (M[AB][01]_CLK_[PN])) and leaves minimum internal clocks running to maintain memory channel bit lock, PLL lock, and to decode a maintenance command to exit the low power mode. Maintenance commands can be used to enter and exit LP1 as received at the command state machine 702. Alternately, the test and pervasive block 714 can be used to enter and exit LP1 mode. While in LP1 mode, the memory hub device 104 can process service interface instructions, such as scan communication (SCOM) operations. However, some of the maintenance commands and configured command sequence operations may not function due to the functional clock gating. In an exemplary embodiment, the wake up time for this sequence is around 1000 nanoseconds as determined by the specification of the memory devices 509 (e.g., DDR3) to transition out of LP1 mode.

A second low power mode (LP2) may also be supported by the memory hub device 104. In an exemplary embodiment, the memory hub device 104 gates off nearly all of its running clock domains to drastically reduce power in LP2. Before entering LP2, the memory controller 110 can command that the memory devices 509 be placed into self refresh mode. The memory hub device 104 shuts off the memory device clocks (e.g., (M[AB][01]_CLK_[PN])) and leaves minimum internal clocks running to decode service interface commands to exit the low power mode. In an exemplary embodiment, only service interface commands as processed at the test and pervasive block 714 can be used to enter and exit LP2 mode. An LP2 control bit may be maintained in a general purpose (GP) register in the FSI clock domain. PLLs and memory channel links can unlock in this state. While in LP2 mode, the memory hub device 104 processes service interface instructions, such as SCOM operations received at the test and pervasive block 714. However, maintenance commands and configured command sequence operations may be non-functional due to the functional clock gating. In an exemplary embodiment, the wake up time for this sequence is around 10 milliseconds to transition out of LP2 mode.

The memory hub device 104 supports mixing of both x4 (4-bit) and x8 (8-bit) DDR3 SDRAM devices on the same data port. Configuration bits indicate the device width associated with each rank (CS) of memory. All data strobes can be used when accessing ranks with x4 devices, while half of the data strobes are used when accessing ranks with x8 devices. An example of specific data bits that can be matched with specific data strobes is shown in table 2.

TABLE 2
Data Bit to Data Strobe Matching

Data Strobe per device width

| Data Bits | x4 | x8 |
|---|---|---|
| ma_dq(0:3) | ma_dqs[pn](0) | Ma_dqs[pn](0) |
| ma_dq(4:7) | ma_dqs[pn](9) | Ma_dqs[pn](0) |
| ma_dq(8:11) | ma_dqs[pn](1) | Ma_dqs[pn](1) |
| ma_dq(12:15) | ma_dqs[pn](10) | Ma_dqs[pn](1) |
| ma_dq(16:19) | ma_dqs[pn](2) | Ma_dqs[pn](2) |
| ma_dq(20:23) | ma_dqs[pn](11) | Ma_dqs[pn](2) |
| ma_dq(24:27) | ma_dqs[pn](3) | Ma_dqs[pn](3) |
| ma_dq(28:31) | ma_dqs[pn](12) | Ma_dqs[pn](3) |
| ma_dq(32:35) | ma_dqs[pn](4) | Ma_dqs[pn](4) |
| ma_dq(36:39) | ma_dqs[pn](13) | Ma_dqs[pn](4) |
| ma_dq(40:43) | ma_dqs[pn](5) | Ma_dqs[pn](5) |
| ma_dq(44:47) | ma_dqs[pn](14) | Ma_dqs[pn](5) |
| ma_dq(48:51) | ma_dqs[pn](6) | Ma_dqs[pn](6) |
| ma_dq(52:55) | ma_dqs[pn](15) | Ma_dqs[pn](6) |
| ma_dq(56:59) | ma_dqs[pn](7) | Ma_dqs[pn](7) |
| ma_dq(60:63) | ma_dqs[pn](16) | Ma_dqs[pn](7) |
| ma_dq(64:67) | ma_dqs[pn](8) | Ma_dqs[pn](8) |
| ma_dq(68:71) | ma_dqs[pn](17) | Ma_dqs[pn](8) |
| mb_dq(0:3) | mb_dqs[pn](0) | mb_dqs[pn](0) |
| mb_dq(4:7) | mb_dqs[pn](9) | mb_dqs[pn](0) |
| mb_dq(8:11) | mb_dqs[pn](1) | mb_dqs[pn](1) |
| mb_dq(12:15) | mb_dqs[pn](10) | mb_dqs[pn](1) |
| mb_dq(16:19) | mb_dqs[pn](2) | mb_dqs[pn](2) |
| mb_dq(20:23) | mb_dqs[pn](11) | mb_dqs[pn](2) |
| mb_dq(24:27) | mb_dqs[pn](3) | mb_dqs[pn](3) |
| mb_dq(28:31) | mb_dqs[pn](12) | mb_dqs[pn](3) |
| mb_dq(32:35) | mb_dqs[pn](4) | mb_dqs[pn](4) |
| mb_dq(36:39) | mb_dqs[pn](13) | mb_dqs[pn](4) |
| mb_dq(40:43) | mb_dqs[pn](5) | mb_dqs[pn](5) |
| mb_dq(44:47) | mb_dqs[pn](14) | mb_dqs[pn](5) |
| mb_dq(48:51) | mb_dqs[pn](6) | mb_dqs[pn](6) |
| mb_dq(52:55) | mb_dqs[pn](15) | mb_dqs[pn](6) |
| mb_dq(56:59) | mb_dqs[pn](7) | mb_dqs[pn](7) |
| mb_dq(60:63) | mb_dqs[pn](16) | mb_dqs[pn](7) |
| mb_dq(64:67) | mb_dqs[pn](8) | mb_dqs[pn](8) |
| mb_dq(68:71) | mb_dqs[pn](17) | mb_dqs[pn](8) |

Data strobe actions taken by the memory hub device 104 are a function of both the device width and command. For example, data strobes can latch read data using DQS mapping in table 2 for reads from x4 memory devices. The data strobes may also latch read data using DQS mapping in table 2 for reads from x8 memory devices, with unused strobes gated and on-die termination is blocked on unused strobe receivers. Data strobes are toggled on strobe drivers for writing to x4 memory devices, while strobe receivers are gated. For writes to x8 memory devices, strobes can be toggled per table 2, leaving unused strobe drivers in high impedance and gating all strobe receivers. For no-operations (NOPs) all strobe drivers are set to high impedance and all strobe receivers are gated.

In an exemplary embodiment, the memory hub device 104 has four groups, (a0, a1, b0, b1) of control signals, (CSN, CKE, ODT) with signal names expanded from: m[ab][01]_[csn(3:0),cke(1:0), odt(1:0)]. When memory hub device 104 is placed in ‘double control port’ mode, signal activation is modified such that all of the m[ab] 1_* signals are driven with the same values as their m[ab]0_* equivalents. Rank decodes, ODT activates and CKE manipulation for *1* signals are ignored and the *0* decodes may work for both *0* and *1* control signals. This mode can be used to reduce loading and ease routing on DIMMs that have no more than 4 ranks per port.

The memory hub device 104 supports a 2N, or 2T, addressing mode that holds memory command signals valid for two memory clock cycles and delays the memory chip select signals by one memory clock cycle. The 2N addressing mode can be used for memory command busses that are so heavily loaded that they cannot meet memory device timing requirements for command/address setup and hold. The memory controller 110 is made aware of the extended address/command timing to ensure that there are no collisions on the memory interfaces. Also, because chip selects to the memory devices are delayed by one cycle, some other configuration register changes may be performed in this mode.

In order to reduce power dissipated by the memory hub device 104, a ‘return to High-Z’ mode is supported for the memory command busses. Memory command busses, e.g., address and control busses 614 and 614′ of FIG. 6, can include the following signals: m[ab]_a(0:15), m[ab]_bnk(0:2), m[ab]_[rasn, casn, wen]. When the return to High-Z mode is activated, memory command signals go into the high impedance (High-Z) state during memory device deselect command decodes.

During DDR3 read and write operations, the memory hub device 104 can activate DDR3 on-die termination (ODT) control signals, m[ab][01]_odt(0:1) for a configured window of time. The specific signals activated are a function of read/write command, rank and configuration. Memory commands issued to one of the A and B ports cannot activate ODT signals from the opposite port. In an exemplary embodiment, each of the 8 ODT control signals has 16 configuration bits controlling its activation for reads and write to the 8 ranks within the same DDR3 port. When a read or write command is performed, ODTs may be activated if the configuration bit for the selected rank is enabled. This enables a very flexible ODT capability in order to allow memory device configurations to be controlled in an optimized manner. Memory systems that support mixed x4 and x8 memory devices, (such as 2 socket DDR3 RDIMM systems) can enable ‘Termination Data Query Strobe’, (TDQS) function in a DDR3 mode register. This allows full termination resistor (Rtt) selection, as controlled by ODT, for x4 devices even when mixed with x8 devices. Terminations may be used to minimize signal reflections and improve signal margins.

In an exemplary embodiment, the memory hub device 104 allows the memory controller 110 to manipulate SDRAM clock enable (CKE) and RESET signals directly using a ‘control CKE’ command, ‘refresh’ command and ‘control RESET’ maintenance command. This avoids the use of power down and self refresh enter and exit commands. The memory controller 110 ensures that each memory configuration is properly controlled by this direct signal manipulation. The memory hub device 104 can check for various timing and mode violations and report errors in a fault isolation register (FIR) and status in a rank status register. The registers may be part of the control and status registers 618 of FIG. 6.

In an exemplary embodiment, the memory hub device 104 monitors the ready status of each DDR3 SDRAM rank and uses it to check for invalid memory commands. Errors can be reported in FIR bits. The memory controller 110 also separately tracks the DDR3 ranks status in order to send valid commands. For diagnostics and code checks, the rank status can optionally be polled as bit positions in a status register. The memory hub device 104 can also check for commands issued to depopulated ranks using rank enable (RE) configuration bits in a global settings register. Each of the control ports (A0, A1, B0, B1) of the memory hub device 104 may have 0, 1, 2 or 4 ranks populated. A two-bit field for each control port (8 bits total) can indicate populated ranks in the current configuration.

Rank enable configuration may also indicate mapping of ranks, (and chip selects) to CKE signals. This information can be used to track ‘Power Down’ and ‘Self Refresh’ status of each memory rank as ‘refresh’ and ‘CKE control’ commands are processed. The rank status register can also track the reset status of each command port, A and B. Invalid commands issued to ranks in the reset state may be reported in the FIR bits.

The memory hub device 104 can also generate command and address parity driven to an external registering clock driver (RCD) either on a RDIMM or on a DIMM using the m[ab]_par signals. The memory hub device 104 samples the returned, negative active parity error signals, m[ab]_errn, sets FIR bits, and enters error recovery states as configured when it detects their activation. The memory hub device 104 parity output signals can be driven one memory clock after the corresponding command and address outputs to satisfy RCD timing requirements. Example parity generation equations are:

ma_par<=

ma_a(15)̂ma_a(14)̂ma_a(13)̂ma_a(12)̂ma_a(11)̂ma_a(10)̂ma_a(9)̂ma_a(8)̂ma_a(7)̂ma_a(6)̂ma_a(5)̂ma_a(4)̂

ma_a(3)̂ma_a(2)̂ma_a(1)̂ma_a(0)̂ma_ba(2)̂ma_ba(1)̂ma_ba(0)̂ma_casn̂ma_rasn̂ma_wen;

mb_par<=

mb_a(15)̂mb_a(14)̂mb_a(13)̂mb_a(12)̂mb_a(11)̂mb_a(10)̂mb_a(9)̂mb_a(8)̂mb_a(7)̂mb_a(6)̂mb_a(5)̂mb_a(4)̂

mb_a(3)̂mb_a(2)̂mb_a(1)̂mb_a(0)̂mb_ba(2)̂mb_ba(1)̂mb_ba(0)̂mb_casn̂mb_rasn̂mb_wen;

The memory hub device 104 may include both an internal temperature monitor and support for an external thermal monitor event signal. The internal monitor is comprised of a temperature sensor macro, e.g., thermal monitor 716, along with a logic block with two configurable thresholds. The memory hub device 104 can sample incoming m[ab]_eventn signals and sets a FIR bit and enters error recovery states as configured when it detects their activation.

In exemplary embodiments, the memory hub device 104 includes mode register and RCD control word shadow latches. Each time the MRS command and ‘Wr RCD Cntl Word’ maintenance commands are decoded, the memory hub device 104 can store delivered mode data into its internal latches. One complete copy of MRS and RCD mode data may be shadowed for each of the control ports, (M[AB][01]). Along with the shadowed bits themselves, the memory hub device 104 may include an indicator of which ranks in the control port have been written with the shadowed value. If all ranks have been set to the same value then all of these bits are set. If all ranks within a control port have been written to different values then the shadow latches hold the most recently written value, and the most previously written rank will have its per rank indicator bit set.

The values in the Mode Register Shadow latches can be used to configure portions of the memory hub device 104 operation. The registers can be read and written with service interface operations. Also, internal configuration fields can be overridden to use separate configuration register bits instead of the shadowed values.

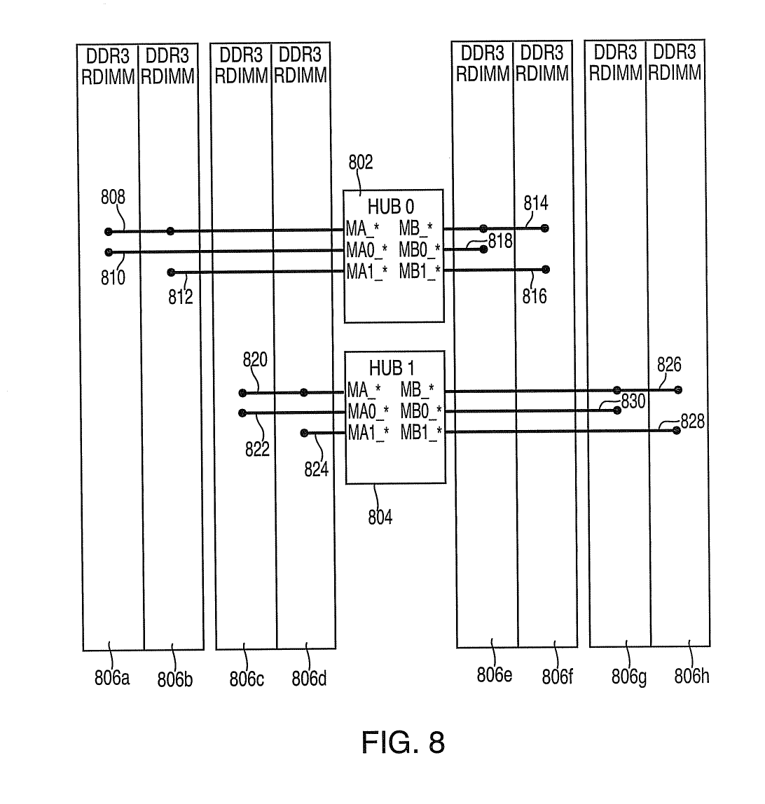

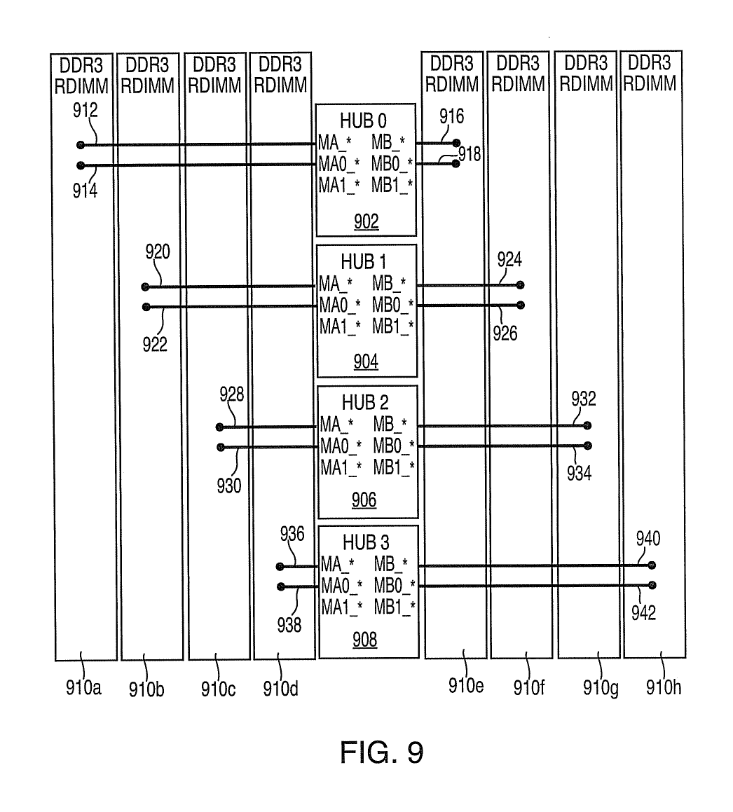

FIG. 8 depicts an example of a pair of memory hub devices, hub0 802 and hub1 804, that represent embodiments of the memory hub device 104 as previously described in reference to FIGS. 1-7, supporting two separate ports of DDR3 RDIMMs with one or two DIMM connectors, or sockets, per port. FIG. 9 depicts four memory hub devices, hub0 902, hub1 904, hub2 906, and hub3 908, which represent embodiments of the memory hub device 104, each with two ports and one RDIMM per port. Memory interface signals in FIG. 8 use a naming convention that indicates connections to RDIMMs 806a, 806b, 806c, 806d, 806e, 806f, 806g, and 806h. The same convention is applied to FIG. 9 in interfacing to RDIMMs 910a, 910b, 910c, 910d, 910e, 910f, 910g, and 910h. The first character ‘M’ indicates a connection to a memory module or subsystem. The second character can be ‘A’ or ‘B’, indicating the port. Signals that have no number in the 3rd character may be connected to all DIMM sockets on the port. Signals with ‘0’ or ‘1’ as the 3rd character may be connected to one of the two DIMM sockets per port. FIGS. 8 and 9 illustrate various memory subsystem layouts for 8 RDIMM socket subsystems (806a-806h and 910a-910h). The abbreviations in FIGS. 8 and 9 are expanded as follows:

MA_*: ma_[a(15:0), ba(2:0), casn, rasn, wen, par, errn, eventn, resetn], ma_dq(71:0), ma_dqs(17:0)

MA0_*: ma0_[csn(3:0), cke(1:0), odt(1:0), clk_[pn]]

MA1_*: ma1_[csn(3:0), cke(1:0), odt(1:0), clk_[pn]]

MB_*: mb_[a(15:0), ba(2:0), casn, rasn, wen, par, errn, eventn, resetn], mb_dq(71:0), mb_dqs(17:0)

MB0_*: mb0_[csn(3:0), cke(1:0), odt(1:0), clk_[pn]]

MB1_*: mb1_[csn(3:0), cke(1:0), odt(1:0), clk_[pn]]

In FIG. 8, hub0 802 is coupled to RDIMM 806a via connections 808 for MA_* signals and 810 for MA0_* signals. Hub0 802 is further coupled to RDIMM 806b via connections 808 for MA_* signals and 812 for MA1_* signals. Hub0 802 is also coupled to RDIMM 806f via connections 814 for MB_* signals and 816 for MB1_* signals. Additionally, hub0 802 is also coupled to RDIMM 806e via connections 814 for MB_* signals and 818 for MB0_* signals. Similarly, hub1 804 is coupled to RDIMM 806c via connections 820 for MA_* signals and 822 for MA0_* signals. Hub1 804 is further coupled to RDIMM 806d via connections 820 for MA_* signals and 824 for MA1_* signals. Hub1 804 is also coupled to RDIMM 806h via connections 826 for MB_* signals and 828 for MB1_* signals. Additionally, hub1 804 is also coupled to RDIMM 806g via connections 826 for MB_* signals and 830 for MB0_* signals.

In FIG. 9, hub0 902 is coupled to RDIMM 910a via connections 912 for MA_* signals and 914 for MA0_* signals. Hub0 902 is also coupled to RDIMM 910e via connections 916 for MB_* signals and 918 for MB0_* signals. Hub1 904 is coupled to RDIMM 910b via connections 920 for MA_* signals and 922 for MA0_* signals. Hub1 904 is further coupled to RDIMM 910f via connections 924 for MB_* signals and 926 for MB0_* signals. Hub2 906 is coupled to RDIMM 910c via connections 928 for MA_* signals and 930 for MA0_* signals. Hub2 906 is further coupled to RDIMM 910g via connections 932 for MB_* signals and 934 for MB0_* signals. Hub3 908 is coupled to RDIMM 910d via connections 936 for MA_* signals and 938 for MA0_* signals. Hub3 908 is further coupled to RDIMM 910h via connections 940 for MB_* signals and 942 for MB0_* signals.

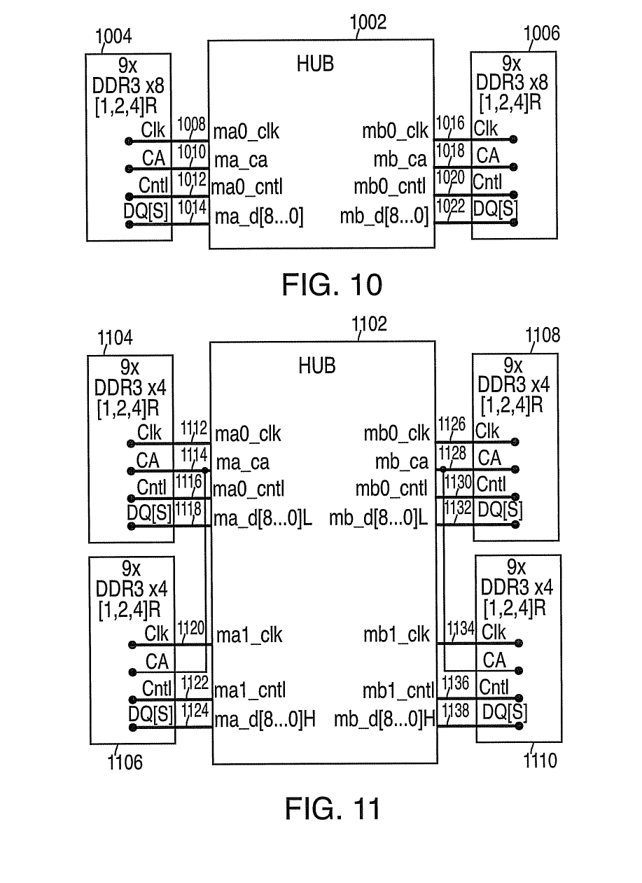

In exemplary embodiments, the memory hub device 104 of FIG. 1-7 supports two separate ports of DDR3 SDRAM devices, e.g., ports 106 of FIG. 1, enabling integration of the memory hub device 104 on a DIMM. Memory interface signals in FIGS. 10-13 use a naming convention that indicates connections to SDRAMs in FIGS. 10-13. The first character ‘M’ indicates a connection to the memory devices. The second character can be ‘A’ or ‘B’, indicating the port. FIGS. 10-13 illustrate various memory subsystem layouts for interconnections to memory devices that can be implemented on a memory module (e.g., a DIMM) or other subsystem (e.g., a memory card). Abbreviations in FIGS. 10-13 are expanded as follows:

ma0_clk: ma0_clk_[pn]

ma_ca_: ma_[a(15:0), ba(2:0), casn, rasn, wen, par, errn, eventn, resetn]

ma0_cntl: ma0_[csn(3:0), cke(1:0), odt(1:0)]

ma_d[8.0]: ma_dq(71:64), ma_dqs(17,8); ma_dq(63:56), ma_dqs(16,7); ma_dq(55:48),

ma_dqs(15,6); ma_dq(47:40), ma_dqs(14,5);

ma_dq(39:32), ma_dqs(13,4); ma_dq(31:24), ma_dqs(12,3); ma_dq(23:16),

ma_dqs(11,2); ma_dq(15:8), ma_dqs(10,1); ma_dq(7:0),

ma_dqs(9,0)

ma_dh[8.0]: ma_dq(71:68), ma_dqs(17); ma_dq(63:60), ma_dqs(16); ma_dq(55:52),

ma_dqs(15); ma_dq(47:44), ma_dqs(14);

ma_dq(39:36), ma_dqs(13); ma_dq(31:28), ma_dqs_(12); ma_dq(23:20), ma_dqs(11);

ma_dq(15:12), ma_dqs(10); ma_dq(7:4),

ma_dqs(9)

ma_dl[8.0]: ma_dq(67:64), ma_dqs(8); ma_dq(59:56), ma_dqs(7); ma_dq(51:48),

ma_dqs(6); ma_dq(43:40), ma_dqs(5);

ma_dq(35:32), ma_dqs(4); ma_dq(27:24), ma_dqs(3); ma_dq(19:16), ma_dqs(2);

ma_dq(11:8), ma_dqs(1); ma_dq(3:0), ma_dqs(0)

mb* is expanded similarly.

FIG. 10 depicts a dual row DIMM embodiment with 2 DDR3 ports each supporting 1, 2 or 4 ranks of x8 DDR3 SDRAM chips. Hub 1002 represents an embodiment of the memory hub device 104 as previously described in reference to FIGS. 1-7. The hub 1002 is coupled to a group of nine DDR3 x8 devices 1004 and another group of nine DDR3 x8 devices 1006. Connections 1008, 1010, 1012 and 1014 represent port A connections between the hub 1002 and the group of nine DDR3 x8 devices 1004 for ma0_clk, ma_ca, ma0_cntl, and ma_d[8.0] respectively. Connections 1016, 1018, 1020 and 1022 represent port B connections between the hub 1002 and the group of nine DDR3 x8 devices 1006 for mb0_clk, mb_ca, mb0_cntl, and mb_d[8.0] respectively.

FIG. 11 depicts an example of a dual row DIMM embodiment with 2 DDR3 ports each supporting 1, 2 or 4 ranks of x4 DDR3 SDRAM chips. Hub 1102 represents an embodiment of the memory hub device 104 as previously described in reference to FIGS. 1-7. The hub 1102 is coupled to four groups of nine DDR3 x4 devices 1104, 1106, 1108 and 1110. Connections 1112, 1114, 1116 and 1118 represent port A connections between the hub 1002 and the group of nine DDR3 x4 devices 1104 for ma0_clk, ma_ca, ma0_cntl, and ma_d[8.0]L respectively. Connections 1120, 1122 and 1124 represent port A connections between the hub 1102 and the group of nine DDR3 x4 devices 1106 for ma1_clk, ma1_cntl, and ma_d[8.0]H respectively. Connection 1114 also provides ma_ca from the hub 1102 to the group of nine DDR3 x4 devices 1106. Connections 1126, 1128, 1130 and 1132 represent port B connections between the hub 1002 and the group of nine DDR3 x4 devices 1108 for mb0_clk, mb_ca, mb0_cntl, and mb_d[8.0]L respectively. Connections 1134, 1136 and 1138 represent port B connections between the hub 1102 and the group of nine DDR3 x4 devices 1110 for mb1_clk, mb1_cntl, and mb_d[8.0]H respectively. Connection 1128 also provides mb_ca from the hub 1102 to the group of nine DDR3 x4 devices 1110.

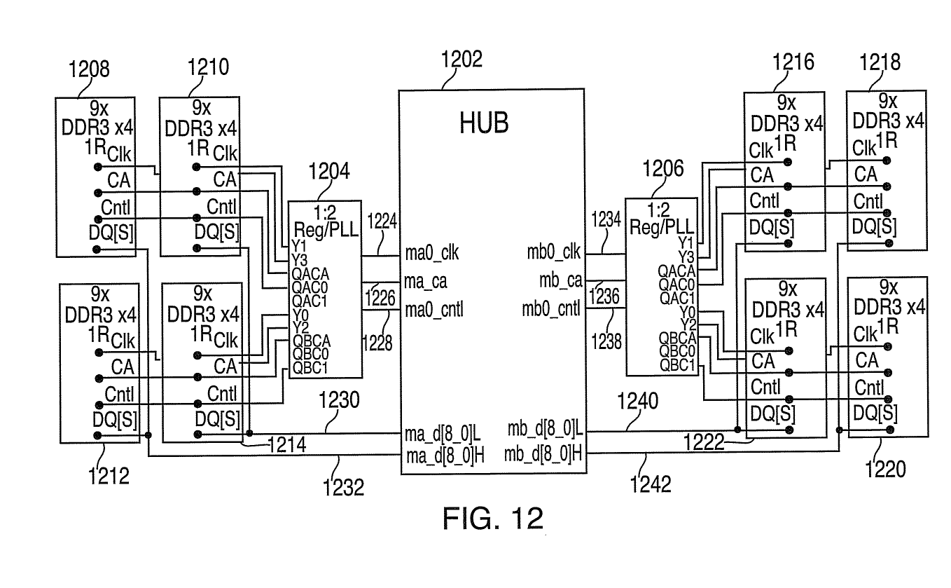

FIG. 12 depicts an example of a quad row DIMM embodiment with 2 DDR3 ports each with 2 ranks of x4 DDR3 SDRAM chips and 2, 1:2 register devices. Hub 1202 represents an embodiment of the memory hub device 104 as previously described in reference to FIGS. 1-7. The hub 1202 is coupled to two register/PLL devices 1204 and 1206, as well as eight groups of nine DDR3 x4 devices 1208, 1210, 1212, 1214, 1216, 1218, 1220, and 1222. The register/PLL devices 1204 and 1206 provide address latching and timing/control signal adjustments (e.g., address, command and control re-drive circuitry and clock re-alignment and re-drive circuitry), similar to the register/PLL logic 316 of FIG. 3. The hub 1202 is coupled to the register/PLL device 1204 via port A connections 1224, 1226, and 1228 for ma0_clk, ma_ca, and ma0_cntl respectively. Data and data strobes on ma_d[8.0]L/H may interface directly between the hub 1202 and the groups of nine DDR3 x4 devices 1208, 1210, 1212 and 1214 via port A connections 1230 and 1232, bypassing the register/PLL device 1204. In similar fashion, the hub 1202 is coupled to the register/PLL device 1206 via port B connections 1234, 1236, and 1238 for mb0_clk, mb_ca, and mb0_cntl respectively. Data and data strobes on mb_d[8.0]L/H may interface directly between the hub 1202 and the groups of nine DDR3 x4 devices 1216, 1218, 1220 and 1222 via port B connections 1240 and 1242, bypassing the register/PLL device 1206.

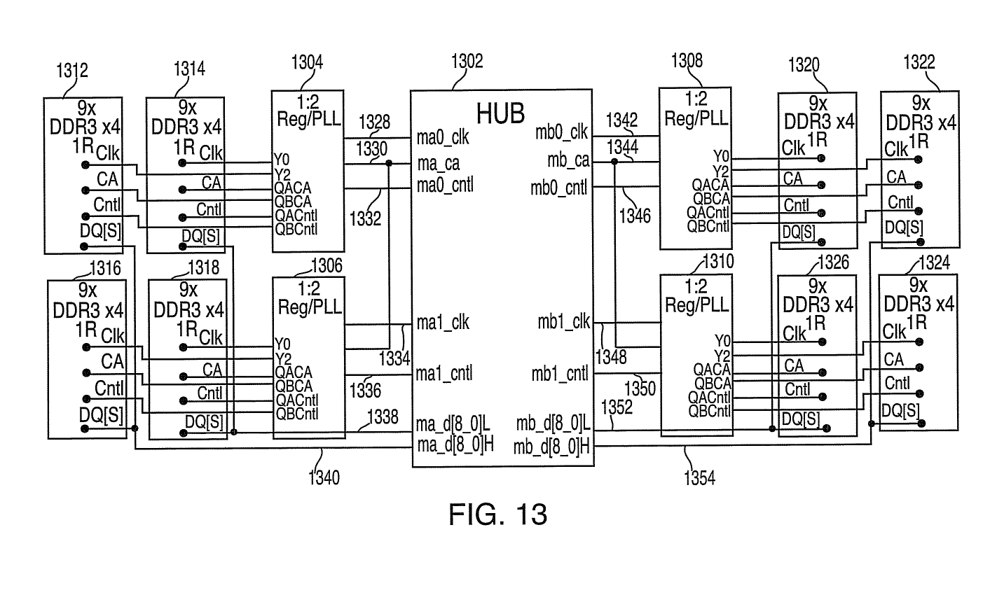

FIG. 13 depicts an example of a quad row DIMM embodiment with 2 DDR3 ports each with 2 or 4 ranks of x4 DDR3 SDRAM chips and 4, 1:4 register devices. Hub 1302 represents an embodiment of the memory hub device 104 as previously described in reference to FIGS. 1-7. The hub 1302 is coupled to four register/PLL devices 1304, 1306, 1308 and 1310, as well as eight groups of nine DDR3 x4 devices 1312, 1314, 1316, 1318, 1320, 1322, 1324, and 1326. The register/PLL devices 1304-1310 provide address latching and timing/control signal adjustments, similar to the register/PLL logic 316 of FIG. 3. The hub 1302 is coupled to the register/PLL device 1304 via port A connections 1328, 1330, and 1332 for ma0_clk, ma_ca, ma0_cntl respectively. The hub 1302 is coupled to the register/PLL device 1306 via port A connections 1334, 1330, and 1336 for ma1_clk, ma_ca, and ma1_cntl. Data and data strobes on ma_d[8.0]L/H may interface directly between the hub 1302 and the groups of nine DDR3 x4 devices 1312, 1314, 1316 and 1318 via port A connections 1338 and 1340, bypassing the register/PLL devices 1304 and 1306. In similar fashion, the hub 1302 is coupled to the register/PLL device 1308 via port B connections 1342, 1344, and 1346 for mb0_clk, mb_ca, and mb0_cntl respectively. The hub 1302 is also coupled to the register/PLL device 1310 via port B connections 1348, 1344, and 1350 for mb1_clk, mb_ca, and mb1_cntl respectively. Data and data strobes on mb_d[8.0]L/H may interface directly between the hub 1202 and the groups of nine DDR3 x4 devices 1320, 1322, 1324 and 1326 via port B connections 1352 and 1354, bypassing the register/PLL devices 1308 and 1310.

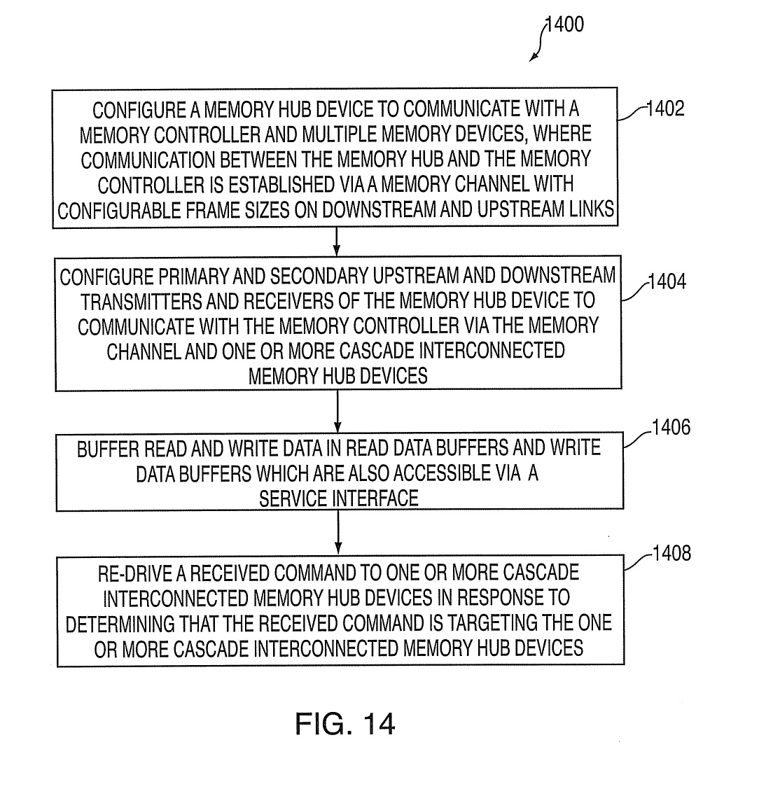

FIG. 14 depicts a process 1400 for providing an enhanced cascade interconnected memory system 100 that may be implemented as described in reference to FIGS. 1-13. The memory system 100 can be configured in variety of architectures, e.g., planar or integrated on a memory module. The memory hub device 104 may also refer to the hub embodiments in FIGS. 8-13, as depicted in various interconnection configurations with different module and memory device configurations that can vary on a per port basis. At block 1402, the memory hub device 104 is configured to communicate with memory controller 110 and multiple memory devices, e.g., DRAMs 509, where communication between the memory hub 104 and the memory controller 110 is established via memory channel 102 with configurable frame sizes on downstream and upstream link segments 116 and 118. In an exemplary embodiment, the unidirectional downstream link segments 116 include at least 13 data bit lanes, 2 spare bit lanes and a downstream clock, coupled to the memory controller 110 and operable for transferring data frames configurable between 8, 12 and 16 transfers per frame, with each transfer comprised of multiple bit lanes. The unidirectional upstream link segments 118 may include at least 20 bit lanes, 2 spare bit lanes and an upstream clock, coupled to the memory controller 110 and operable for transferring data frames comprised of 8 transfers per frame, with each transfer comprised of multiple bit lanes.

At block 1404, the primary and secondary upstream and downstream transmitters and receivers (PDS Rx 206, SDS Tx 208, PUS Tx 210, and SUS Rx 212) of the memory hub device 104 are configured to communicate with the memory controller 110 via the memory channel 102 and one or more cascade interconnected memory hub devices 104. Configuration can establish timing via timing logic, such as RME 326 and PLLs 306 and 310, using the service interface 124. Further configuration adjustments can be made to support specific memory device and register connections to the memory hub device 104.

At block 1406, the memory hub device buffers read and write data in read data buffers 606 and write data buffers 611 which are also accessible via the service interface 124. In an exemplary embodiment, read data buffering is performed using 4 read data buffers, each 72-bits wide and 8-transfers deep, while write data buffering is performed using 16 write data buffers, each 72-bits wide and 8-transfers deep.

At block 1408, the memory hub device 104 re-drives received commands to one or more cascade interconnected memory hub devices 104 in response to determining that the received commands target the one or more cascade interconnected memory hub devices 104 rather than the memory hub device 104 that received the commands. The memory hub device 104 may perform a variety of other functions, such as interface to memory devices and/or RDIMMs. Memory interfacing can include a 2T memory addressing mode to hold memory command signals valid for two memory clock cycles and delay memory chip select signals by one memory clock cycle, as well as a variable driver impedance, slew rate and termination resistance for data input/output connections, and configurable data latencies.

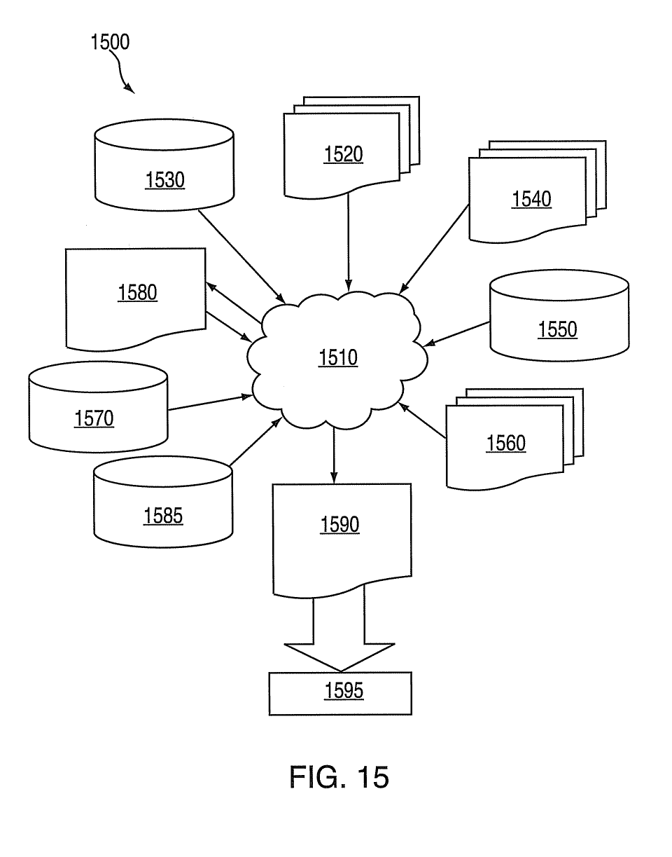

FIG. 15 shows a block diagram of an exemplary design flow 1500 used for example, in semiconductor IC logic design, simulation, test, layout, and manufacture. Design flow 1500 includes processes and mechanisms for processing design structures or devices to generate logically or otherwise functionally equivalent representations of the design structures and/or devices described above and shown in FIGS. 1-13. The design structures processed and/or generated by design flow 1500 may be encoded on machine readable transmission or storage media to include data and/or instructions that when executed or otherwise processed on a data processing system generate a logically, structurally, mechanically, or otherwise functionally equivalent representation of hardware components, circuits, devices, or systems. Design flow 1500 may vary depending on the type of representation being designed. For example, a design flow 1500 for building an application specific IC (ASIC) may differ from a design flow 1500 for designing a standard component or from a design flow 1500 for instantiating the design into a programmable array, for example a programmable gate array (PGA) or a field programmable gate array (FPGA) offered by Altera® Inc. or Xilinx® Inc.

FIG. 15 illustrates multiple such design structures including an input design structure 1520 that is preferably processed by a design process 1510. Design structure 1520 may be a logical simulation design structure generated and processed by design process 1510 to produce a logically equivalent functional representation of a hardware device. Design structure 1520 may also or alternatively comprise data and/or program instructions that when processed by design process 1510, generate a functional representation of the physical structure of a hardware device. Whether representing functional and/or structural design features, design structure 1520 may be generated using electronic computer-aided design (ECAD) such as implemented by a core developer/designer. When encoded on a machine-readable data transmission, gate array, or storage medium, design structure 1520 may be accessed and processed by one or more hardware and/or software modules within design process 1510 to simulate or otherwise functionally represent an electronic component, circuit, electronic or logic module, apparatus, device, or system such as those shown in FIGS. 1-13. As such, design structure 1520 may comprise files or other data structures including human and/or machine-readable source code, compiled structures, and computer-executable code structures that when processed by a design or simulation data processing system, functionally simulate or otherwise represent circuits or other levels of hardware logic design. Such data structures may include hardware-description language (HDL) design entities or other data structures conforming to and/or compatible with lower-level HDL design languages such as Verilog and VHDL, and/or higher level design languages such as C or C++.

Design process 1510 preferably employs and incorporates hardware and/or software modules for synthesizing, translating, or otherwise processing a design/simulation functional equivalent of the components, circuits, devices, or logic structures shown in FIGS. 1-13 to generate a netlist 1580 which may contain design structures such as design structure 1520. Netlist 1580 may comprise, for example, compiled or otherwise processed data structures representing a list of wires, discrete components, logic gates, control circuits, I/O devices, models, etc. that describes the connections to other elements and circuits in an integrated circuit design. Netlist 1580 may be synthesized using an iterative process in which netlist 1580 is resynthesized one or more times depending on design specifications and parameters for the device. As with other design structure types described herein, netlist 1580 may be recorded on a machine-readable data storage medium or programmed into a programmable gate array. The medium may be a non-volatile storage medium such as a magnetic or optical disk drive, a programmable gate array, a compact flash, or other flash memory. Additionally, or in the alternative, the medium may be a system or cache memory, buffer space, or electrically or optically conductive devices and materials on which data packets may be transmitted and intermediately stored via the Internet, or other networking suitable means.

Design process 1510 may include hardware and software modules for processing a variety of input data structure types including netlist 1580. Such data structure types may reside, for example, within library elements 1530 and include a set of commonly used elements, circuits, and devices, including models, layouts, and symbolic representations, for a given manufacturing technology (e.g., different technology nodes, 32 nm, 45 nm, 90 nm, etc.). The data structure types may further include design specifications 1540, characterization data 1550, verification data 1560, design rules 1570, and test data files 1585 which may include input test patterns, output test results, and other testing information. Design process 1510 may further include, for example, standard mechanical design processes such as stress analysis, thermal analysis, mechanical event simulation, process simulation for operations such as casting, molding, and die press forming, etc. One of ordinary skill in the art of mechanical design can appreciate the extent of possible mechanical design tools and applications used in design process 1510 without deviating from the scope and spirit of the invention. Design process 1510 may also include modules for performing standard circuit design processes such as timing analysis, verification, design rule checking, place and route operations, etc.

Design process 1510 employs and incorporates logic and physical design tools such as HDL compilers and simulation model build tools to process design structure 1520 together with some or all of the depicted supporting data structures along with any additional mechanical design or data (if applicable), to generate a second design structure 1590. Design structure 1590 resides on a storage medium or programmable gate array in a data format used for the exchange of data of mechanical devices and structures (e.g. information stored in a IGES, DXF, Parasolid XT, JT, DRG, or any other suitable format for storing or rendering such mechanical design structures). Similar to design structure 1520, design structure 1590 preferably comprises one or more files, data structures, or other computer-encoded data or instructions that reside on transmission or data storage media and that when processed by an ECAD system generate a logically or otherwise functionally equivalent form of one or more of the embodiments of the invention shown in FIGS. 1-13. In one embodiment, design structure 1590 may comprise a compiled, executable HDL simulation model that functionally simulates the devices shown in FIGS. 1-13.

Design structure 1590 may also employ a data format used for the exchange of layout data of integrated circuits and/or symbolic data format (e.g. information stored in a GDSII (GDS2), GL1, OASIS, map files, or any other suitable format for storing such design data structures). Design structure 1590 may comprise information such as, for example, symbolic data, map files, test data files, design content files, manufacturing data, layout parameters, wires, levels of metal, vias, shapes, data for routing through the manufacturing line, and any other data required by a manufacturer or other designer/developer to produce a device or structure as described above and shown in FIGS. 1-13. Design structure 1590 may then proceed to a stage 1595 where, for example, design structure 1590: proceeds to tape-out, is released to manufacturing, is released to a mask house, is sent to another design house, is sent back to the customer, etc.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The capabilities of the present invention can be implemented in software, firmware, hardware or some combination thereof.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Exemplary embodiments include a computing system with one or more processors and one or more I/O units (e.g., requestors) interconnected to a memory system that contains a memory controller and one or more memory devices. In exemplary embodiments, the memory system includes a processor or memory controller communicating with one or more hub devices (also referred to as “hub chips”) which are attached to one or more ports or channels of the memory controller. The memory controller channels may be operated in parallel, thereby providing an increased data bus width and/or effective bandwidth, operated separately, or a combination therein as determined by the application and/or system design. The hub devices connect and interface to the memory devices either by direct connection (e.g. wires) or by way of one or more intermediate devices such as external buffers, registers, clocking devices, conversion devices, etc. In exemplary embodiments the computer memory system includes a physical memory array comprised of one or more volatile and/or non-volatile storage devices for storing such information as data and instructions. In exemplary embodiments, the hub-based computer memory system has memory devices attached to a communication hub device that is connected to a memory control device (e.g., a memory controller). Also in exemplary embodiments, the hub device is located on a memory module (e.g, a single substrate or assembly that includes two or more hub devices that are cascaded interconnected to each other (and may further connect to another hub device located on another memory module) via the cascade interconnect, daisy chain and/or other memory bus structure.

Hub devices may be connected to the memory controller through a multi-drop or point-to-point bus structure (which may further include a cascade connection to one or more additional hub devices). Memory access requests are transmitted by the memory controller through the bus structure (e.g., the memory bus) to the selected hub(s). In response to receiving the memory access requests, the hub device receives and generally translates and re-drives at least a portion of the received information in the memory access request(s) to the memory devices to initiate such operations as the storing of “write” data from the hub device or to provide “read” data to the hub device. Data read from the memory device(s) is generally encoded into one or more communication packet(s) and transmitted through the memory bus(es) to the memory controller or other requester—although the data may also be used by one or more of the hub devices (e.g. during memory “self-testing”) or by another device having access to the hub, such as a service processor, test equipment, etc.

In alternate exemplary embodiments, the memory controller(s) may be integrated together with one or more processor chips and supporting logic, packaged in a discrete chip (commonly called a “northbridge” chip), included in a multi-chip carrier with the one or more processors and/or supporting logic, or packaged in various alternative forms that best match the application/environment. Any of these solutions may or may not employ one or more narrow/high speed links (e.g. memory channels or ports) to connect to one or more hub chips and/or memory devices.

The memory modules may be implemented by a variety of technologies including a dual in-line memory module (DIMM), a single in-line memory module (SIMM), a triple in-line memory module (TRIMM), and quad in-line memory module (QUIMM), various “small” form-factor modules (such as small outline DIMMs (SO DIMMs), micro DIMMs, etc) and/or other memory module or card structures. In general, a DIMM refers to a circuit board which is often comprised primarily of random access memory (RAM) integrated circuits or die on one or both sides of the board, with signal and/or power contacts also on both sides, along one edge of the board that are generally have different functionality that the directly and/or diagonally opposed contacts. This can be contrasted to a SIMM which is similar is composition but having opposed contacts electrically interconnected and therefore providing the same functionality as each other. For TRIMMs and QUIMMs, at least one side of the board includes two rows on contacts, with other board types having contacts on multiple edges of the board (e.g. opposing and/or adjacent edges on the same side of the board), in areas away from the board edge, etc. Contemporary DIMMs includes 168, 184, 240, 276 and various other signal pin or pad counts, whereas past and future memory modules will generally include as few as tens of contacts to hundreds of contacts. In exemplary embodiments described herein, the memory modules may include one, two or more hub devices.

In exemplary embodiments, the memory bus is constructed using point-to-point connections between hub devices and/or a hub device and the memory controller, although other bus structures such as multi-drop busses may also be used. When separate “upstream” and “downstream” (generally unidirectional) busses are utilized (together comprising the memory “bus”), the “downstream” portion of the memory bus, referred to as the downstream bus, may include command, address, data and other operational, initialization or status information being sent to one or more of the hub devices that are downstream of the memory controller. The receiving hub device(s) may simply forward the information to the subsequent hub device(s) via bypass circuitry; receive, interpret and re-drive the information if it is determined by the hub(s) to be targeting a downstream hub device; re-drive some or all of the information without first interpreting the information to determine the intended recipient; or perform a subset or combination of these functions.

The upstream portion of the memory bus, referred to as the upstream bus, returns requested read data and/or error, status or other operational information, and this information may be forwarded to the subsequent hub devices and/or the memory control device(s) via bypass circuitry; be received, interpreted and re-driven if it is determined by the hub(s) to be targeting an upstream hub device and/or memory controller in the processor complex; be re-driven in part or in total without first interpreting the information to determine the intended recipient; or perform a subset or combination of these functions.

In alternate exemplary embodiments, the point-to-point bus includes a switch, re-drive or bypass mechanism which results in the bus information being directed to one of two or more possible hub devices during downstream communication (communication passing from the memory controller to a hub device on a memory module), and which may also direct upstream information (communication from a hub device on a memory module toward the memory controller), often by way of one or more upstream hub devices. Further embodiments include the use of continuity modules, such as those recognized in the art, which, for example, can be placed between the memory controller and a first populated memory module (e.g., a memory module that includes a hub device that is in communication with one or more memory devices), in a cascade interconnect memory system, such that any intermediate module positions between the memory controller and the first populated memory module includes a means by which information passing between the memory controller and the first populated memory module device can be received even if the one or more intermediate module position(s) do not include a hub device. The continuity module(s) may be installed in any module position(s), subject to any bus restrictions, including the first position (closest to the main memory controller, the last position (prior to any included termination) or any intermediate position(s). The use of continuity modules may be especially beneficial in a multi-module cascade interconnect bus structure, where an intermediate hub device on a memory module is removed and replaced by a continuity module, such that the system continues to operate after the removal of the intermediate hub device/module. In more common embodiments, the continuity module(s) would include either interconnect wires to transfer all required signals from the input(s) to the corresponding output(s), or be re-driven through a repeater device. The continuity module(s) might further include a non-volatile storage device (such as an EEPROM), but would not include conventional main memory storage devices such as one or more volatile memory device(s). In other exemplary embodiments, the continuity or re-drive function may be comprised as a hub device that is not placed on a memory module (e.g. the one or more hub device(s) may be attached directly to the system board or attached to another carrier), and may or may not include other devices connected to it to enable functionality.

In exemplary embodiments, the memory system includes one or more hub devices on one or more memory modules connected to the memory controller via one or more cascade interconnect memory buses, however one or more other bus structure(s) or a combination of bus structures may be implemented to enable communication such as point-to-point bus(es), multi-drop bus(es) or other shared or parallel bus(es), often allow various means of communication (e.g. including both high speed and low speed communication means). Depending on the signaling methods used, the intended operating frequency range, space, power, cost, and other constraints, various alternate bus structures may also be considered. A point-to-point bus may provide optimal performance (e.g. maximum data rate) in systems produced with high frequency signaling utilizing electrical interconnections, due to the reduced signal degradation that may occur as compared to bus structures having branched signal lines (such as “T” nets, multi-drop nets or other forms of “stubs”. However, when used in systems requiring communication with a large number of devices and/or memory subsystems, this method will often result in significant added component cost, increased latency for distant devices and/or increased system power, and may further reduce the total memory density in a given volume of space due to the need for intermediate buffering and/or re-drive of the bus(es).

Although generally not shown in the Figures, the memory modules or hub devices may also include one or more separate bus(es), such as a “presence detect” (e.g. a module serial presence detect bus), an I2C bus, a JTAG bus, an SMBus or other bus(es) which are primarily used for one or more purposes such as the determination of the hub device an/or memory module attributes (generally after power-up), the configuration of the hub device(s) and/or memory subsystem(s) after power-up or during normal operation, bring-up and/or training of the high speed interfaces (e.g. bus(es)), the reporting of fault or status information to the system and/or testing/monitoring circuitry, the determination of specific failing element(s) and/or implementation of bus repair actions such as bitlane and/or segment sparing, the determination of one or more failing devices (e.g. memory and/or support device(s)) possibly with the invoking of device replacement (e.g. device “sparing”), parallel monitoring of subsystem operation or other purposes, etc. The one or more described buses would generally not be intended for primary use as high speed memory communication bus(es). Depending on the bus characteristics, the one or more bus(es) might, in addition to previously described functions, also provide a means by which the valid completion of operations and/or failure identification could be reported by the hub devices and/or memory module(s) to the memory controller(s), the processor, a service processor, a test device and/or other functional element permanently or temporarily in communication with the memory subsystem and/or hub device.

In other exemplary embodiments, performances similar to those obtained from point-to-point bus structures can be obtained by adding switch devices to the one or more communication bus(es). These and other solutions may offer increased memory packaging density at lower power, while otherwise retaining many of the characteristics of a point-to-point bus. Multi-drop busses provide an alternate solution, albeit often limiting the maximum operating frequency to a frequency lower than that available with the use of an optimized point-to-point bus structure, but at a cost/performance point that may otherwise be acceptable for many applications. Optical bus solutions may permit significantly increased frequency and bandwidth vs. the previously-described bus structures, using point-to-point or multi-drop or related structures, but may incur cost and/or space impacts when using contemporary technologies.

As used herein the term “buffer” or “buffer device” refers to an interface device which includes temporary storage circuitry (such as when used in a computer), especially one that accepts information at one rate (e.g. a high data rate) and delivers it another (e.g. a lower data rate), and vice versa. Data rate multipliers of 2:1, 4:1, 5:1, 6:1, 8:1, etc. may be utilized in systems utilizing one or more buffer device(s) such as those described herein, with such systems often supporting multiple data rate multipliers—generally on a per-port basis. In exemplary embodiments, a buffer is an electronic device that provides compatibility between two signals (e.g. one or more of changing voltage levels, converting data rates, etc.). The term “hub” may be used interchangeably with the term “buffer” in some applications. A hub is generally described as a device containing multiple ports that enable connection to one or more devices on each port. A port is a portion of an interface that serves a congruent I/O functionality (e.g., in the exemplary embodiment, a port may be utilized for sending and receiving information such as data, address, command and control information over one of the point-to-point links (which may further be comprised of one or more bus(es)), thereby enabling communication with one or more memory devices. A hub may further be described as a device that connects several systems, subsystems, or networks together, and may include logic to merge local data into a communication data stream passing through the hub device. A passive hub may simply forward messages, while an active hub, or repeater, may amplify, re-synchronize and/or refresh a stream of data (e.g. data packets) which otherwise would deteriorate in signal quality over a distance. The term hub device, as used herein, refers primarily to one or more active devices that also include logic (including hardware and/or software) for directly and/or indirectly connecting to and communicating with one or more memory device(s) utilizing one communication means to another communication means (e.g. one or more of an upstream and downstream bus and/or other bus structure). The hub device may further include one or more traditional “memory controller” functions such as the conversion of high-level address and/or commands into technology-specific memory device information, scheduling and/or re-ordering of memory operations, the inclusion of local data caching circuitry and/or include other traditional memory controller and/or memory system functions.

Also as used herein, the term “bus” refers to one of the sets of conductors (e.g., wires, printed circuit board traces or other connection means) between devices, cards, modules and/or other functional units. The data bus, address bus and control signals, despite their names, generally constitute a single bus since each are often useless without the others. A bus may include a plurality of signal lines, each signal line having two or more connection points that form a transmission path that enables communication between two or more transceivers, transmitters and/or receivers. The term “channel”, as used herein, refers to the one or more busses containing information such as data, address(es), command(s) and control(s) to be sent to and received from a system or subsystem, such as a memory, processor or I/O system. Note that this term is often used in conjunction with I/O or other peripheral equipment; however the term channel has also been utilized to describe the interface between a processor or memory controller and one of one or more memory subsystem(s).

Further, as used herein, the term “daisy chain” refers to a bus wiring structure in which, for example, device A is wired to device B, device B is wired to device C, etc. . . . The last device is typically wired to a resistor or terminator. All devices may receive identical signals or, in contrast to a simple bus, each device may modify, re-drive or otherwise act upon one or more signals before passing them on. A “cascade” or cascade interconnect’ as used herein refers to a succession of stages or units or a collection of interconnected networking devices, typically hubs, in which the hubs operate as a logical repeater, further permitting merging data to be concentrated into the existing data stream. The terms daisy chain and cascade connect may be used interchangeably when a daisy chain structure includes some form of re-drive and/or “repeater” function. Also as used herein, the term “point-to-point” bus and/or link refers to one or a plurality of signal lines that may each include one or more terminators. In a point-to-point bus and/or link, each signal line has two transceiver connection points, with each transceiver connection point coupled to transmitter circuitry, receiver circuitry or transceiver circuitry. A signal line refers to one or more electrical conductors, optical carriers and/or other information transfer method, generally configured as a single carrier or as two or more carriers, in a twisted, parallel, or concentric arrangement, used to transport at least one logical signal.

Memory devices are generally defined as integrated circuits that are comprised primarily of memory (storage) cells, such as DRAMs (Dynamic Random Access Memories), SRAMs (Static Random Access Memories), FeRAMs (Ferro-Electric RAMs), MRAMs (Magnetic Random Access Memories), ORAMs (optical random access memories), Flash Memories and other forms of random access and/or pseudo random access storage devices that store information in the form of electrical, optical, magnetic, biological or other means. Dynamic memory device types may include asynchronous memory devices such as FPM DRAMs (Fast Page Mode Dynamic Random Access Memories), EDO (Extended Data Out) DRAMs, BEDO (Burst EDO) DRAMs, SDR (Single Data Rate) Synchronous DRAMs, DDR (Double Data Rate) Synchronous DRAMs, QDR (Quad Data Rate) Synchronous DRAMs, Toggle-mode DRAMs or any of the expected follow-on devices such as DDP2, DDR3, DDR4 and related technologies such as Graphics RAMs, Video RAMs, LP RAMs (Low Power DRAMs) which are often based on at least a subset of the fundamental functions, features and/or interfaces found on related DRAMs.

Memory devices may be utilized in the form of chips (die) and/or single or multi-chip packages of various types and configurations. In multi-chip packages, the memory devices may be packaged with other device types such as other memory devices, logic chips, analog devices and programmable devices, and may also include passive devices such as resistors, capacitors and inductors. These packages may include an integrated heat sink or other cooling enhancements, which may be further attached to the immediate carrier or another nearby carrier or heat removal system.

Module support devices (such as buffers, hubs, hub logic chips, registers, PLL's, DLL's, non-volatile memory, etc) may be comprised of multiple separate chips and/or components, may be combined as multiple separate chips onto one or more substrates, may be combined onto a single package and/or or integrated onto a single device—based on technology, power, space, cost and other tradeoffs. In addition, one or more of the various passive devices such as resistors, capacitors may be integrated into the support chip packages and/or into the substrate, board or raw card itself, based on technology, power, space, cost and other tradeoffs. These packages may also include one or more heat sinks or other cooling enhancements, which may be further attached to the immediate carrier or be part of an integrated heat removal structure that contacts more than one support and/or memory devices.

Memory devices, hubs, buffers, registers, clock devices, passives and other memory support devices and/or components may be attached to the memory subsystem via various methods including solder interconnects, conductive adhesives, socket assemblies, pressure contacts and other methods which enable communication between the two or more devices and/or carriers via electrical, optical or alternate communication means.

The one or more memory modules, memory cards and/or alternate memory subsystem assemblies and/or hub devices may be electrically connected to the memory system, processor complex, computer system or other system environment via one or more methods such as soldered interconnects, connectors, pressure contacts, conductive adhesives, optical interconnects and other communication and power delivery methods. Inter-connection systems may include mating connectors (e.g. male/female connectors), conductive contacts and/or pins on one carrier mating with a compatible male or female connection means, optical connections, pressure contacts (often in conjunction with a retaining mechanism) and/or one or more of various other communication and power delivery methods. The interconnection(s) may be disposed along one or more edges of the memory assembly, may include one or more rows of interconnections and/or be located a distance from an edge of the memory subsystem depending on such application requirements as the connection structure, the number of interconnections required, performance requirements, ease of insertion/removal, reliability, available space/volume, heat transfer/cooling, component size and shape and other related physical, electrical, optical, visual/physical access, etc. Electrical interconnections on contemporary memory modules are often referred to as contacts, pins, tabs, etc. Electrical interconnections on a contemporary electrical connector are often referred to as contacts, pads, pins, pads, etc.

As used herein, the term memory subsystem refers to, but is not limited to one or more memory devices, one or more memory devices and associated interface and/or timing/control circuitry and/or one or more memory devices in conjunction with a memory buffer, hub device, and/or switch. The term memory subsystem may also refer to a storage function within a memory system, comprised of one or more memory devices in addition to one or more supporting interface devices and/or timing/control circuitry and/or one or more memory buffers, hub devices or switches, identification devices, etc.; generally assembled onto one or more substrate(s), card(s), module(s) or other carrier type(s), which may further include additional means for attaching other devices. The memory modules described herein may also be referred to as memory subsystems because they include one or more memory devices and other supporting device(s).

Additional functions that may reside local to the memory subsystem and/or hub device include write and/or read buffers, one or more levels of local memory cache, local pre-fetch logic (allowing for self-initiated pre-fetching of data), data encryption/decryption, compression/de-compression, address and/or command protocol translation, command prioritization logic, voltage and/or level translation, error detection and/or correction circuitry on one or more busses, data scrubbing, local power management circuitry (which may further include status reporting), operational and/or status registers, initialization circuitry, self-test circuitry (testing logic and/or memory in the subsystem), performance monitoring and/or control, one or more co-processors, search engine(s) and other functions that may have previously resided in the processor, memory controller or elsewhere in the memory system. Memory controller functions may also be included in the memory subsystem such that one or more of non-technology-specific commands/command sequences, controls, address information and/or timing relationships can be passed to and from the memory subsystem, with the subsystem completing the conversion, re-ordering, re-timing between the non-memory technology-specific information and the memory technology-specific communication means as necessary. By placing more technology-specific functionality local to the memory subsystem, such benefits as improved performance, increased design flexibility/extendibility, etc., may be obtained, often while making use of unused circuits within the subsystem.

Memory subsystem support device(s) may be directly attached to the same substrate or assembly onto which the memory device(s) are attached, or may be mounted to a separate interposer, substrate, card or other carrier produced using one or more of various plastic, silicon, ceramic or other materials which include electrical, optical or other communication paths to functionally interconnect the support device(s) to the memory device(s) and/or to other elements of the memory subsystem or memory system.

Information transfers (e.g. packets) along a bus, channel, link or other interconnection means may be completed using one or more of many signaling options. These signaling options may include one or more of such means as single-ended, differential, optical or other communication methods, with electrical signaling further including such methods as voltage and/or current signaling using either single or multi-level approaches. Signals may also be modulated using such methods as time or frequency, non-return to zero, phase shift keying, amplitude modulation and others. Signal voltage levels are expected to continue to decrease, with 1.5V, 1.2V, 1V and lower signal voltages expected, as a means of reducing power, accommodating reduced technology breakdown voltages, etc.—in conjunction with or separate from the power supply voltages. One or more power supply voltages, e.g. for DRAM memory devices, may drop at a slower rate that the I/O voltage(s) due in part to the technological challenges of storing information in the dynamic memory cells.

One or more clocking methods may be utilized within the memory subsystem and the memory system itself, including global clocking, source-synchronous clocking, encoded clocking or combinations of these and other methods. The clock signaling may be identical to that of the signal (often referred to as the bus “data”) lines themselves, or may utilize one of the listed or alternate methods that is more conducive to the planned clock frequency(ies), and the number of clocks required for various operations within the memory system/subsystem(s). A single clock may be associated with all communication to and from the memory, as well as all clocked functions within the memory subsystem, or multiple clocks may be sourced using one or more methods such as those described earlier. When multiple clocks are used, the functions within the memory subsystem may be associated with a clock that is uniquely sourced to the memory subsystem and/or may be based on a clock that is derived from the clock included as part of the information being transferred to and from the memory subsystem (such as that associated with an encoded clock). Alternately, a unique clock may be used for the information transferred to the memory subsystem, and a separate clock for information sourced from one (or more) of the memory subsystems. The clocks themselves may operate at the same or frequency multiple of the communication or functional frequency, and may be edge-aligned, center-aligned or placed in an alternate timing position relative to the data, command or address information.

Information passing to the memory subsystem(s) will generally be composed of address, command and data, as well as other signals generally associated with requesting or reporting status or error conditions, resetting the memory, completing memory or logic initialization and/or other functional, configuration or related operations. Information passing from the memory subsystem(s) may include any or all of the information passing to the memory subsystem(s), however generally will not include address and command information. The information passing to or from the memory subsystem(s) may be delivered in a manner that is consistent with normal memory device interface specifications (generally parallel in nature); however, all or a portion of the information may be encoded into a ‘packet’ structure, which may further be consistent with future memory interfaces or delivered using an alternate method to achieve such goals as an increase communication bandwidth, an increase in memory subsystem reliability, a reduction in power and/or to enable the memory subsystem to operate independently of the memory technology. In the latter case, the memory subsystem (e.g. the hub device) would convert and/or schedule, time, etc. the received information into the format required by the receiving device(s).

Initialization of the memory subsystem may be completed via one or more methods, based on the available interface busses, the desired initialization speed, available space, cost/complexity, the subsystem interconnect structures involved, the use of alternate processors (such as a service processor) which may be used for this and other purposes, etc. In one embodiment, the high speed bus may be used to complete the initialization of the memory subsystem(s), generally by first completing a step-by-step training process to establish reliable communication to one, more or all of the memory subsystems, then by interrogation of the attribute or ‘presence detect’ data associated the one or more various memory assemblies and/or characteristics associated with any given subsystem, and ultimately by programming any/all of the programmable devices within the one or more memory subsystems with operational information establishing the intended operational characteristics for each subsystem within that system. In a cascaded system, communication with the memory subsystem closest to the memory controller would generally be established first, followed by the establishment of reliable communication with subsequent (downstream) subsystems in a sequence consistent with their relative position along the cascade interconnect bus.

A second initialization method would include one in which the high speed bus is operated at one frequency during the initialization process, then at a second (and generally higher) frequency during the normal operation. In this embodiment, it may be possible to initiate communication with any or all of the memory subsystems on the cascade interconnect bus prior to completing the interrogation and/or programming of each subsystem, due to the increased timing margins associated with the lower frequency operation.

A third initialization method might include operation of the cascade interconnect bus at the normal operational frequency(ies), while increasing the number of cycles associated with each address, command and/or data transfer. In one embodiment, a packet containing all or a portion of the address, command and/or data information might be transferred in one clock cycle during normal operation, but the same amount and/or type of information might be transferred over two, three or more cycles during initialization. This initialization process would therefore be using a form of ‘slow’ commands, rather than ‘normal’ commands, and this mode might be automatically entered at some point after power-up and/or re-start by each of the subsystems and the memory controller by way of POR (power-on-reset) logic and/or other methods such as a power-on-rest detection via detection of a slow command identifying that function.

A fourth initialization method might utilize a distinct bus, such as a presence detect bus (such as the one defined in U.S. Pat. No. 5,513,135 to Dell et al., of common assignment herewith), an I2C bus (such as defined in published JEDEC standards such as the 168 Pin DIMM family in publication 21-C revision 7R8) and/or the SMBUS, which has been widely utilized and documented in computer systems using such memory modules. This bus might be connected to one or more modules within a memory system in a daisy chain/cascade interconnect, multi-drop or alternate structure, providing an independent means of interrogating memory subsystems, programming each of the one or more memory subsystems to operate within the overall system environment, and adjusting the operational characteristics at other times during the normal system operation based on performance, thermal, configuration or other changes desired or detected in the system environment.

Other methods for initialization can also be used, in conjunction with or independent of those listed. The use of a separate bus, such as described in the fourth embodiment above, also provides an independent means for both initialization and uses other than initialization, such as described in U.S. Pat. No. 6,381,685 to Dell et al., of common assignment herewith, including changes to the subsystem operational characteristics on-the-fly and for the reporting of and response to operational subsystem information such as utilization, temperature data, failure information or other purposes.

With improvements in lithography, better process controls, the use of materials with lower resistance, increased field sizes and other semiconductor processing improvements, increased device circuit density (often in conjunction with increased die sizes) may facilitate increased function on integrated devices as well as the integration of functions previously implemented on separate devices. This integration can serve to improve overall performance of the memory system and/or subsystem(s), as well as provide such system benefits as increased storage density, reduced power, reduced space requirements, lower cost, higher performance and other manufacturer and/or customer benefits. This integration is a natural evolutionary process, and may result in the need for structural changes to the fundamental building blocks associated with systems.

The integrity of the communication path, the data storage contents and all functional operations associated with each element of a memory system or subsystem can be assured, to a high degree, with the use of one or more fault detection and/or correction methods. Any or all of the various elements may include error detection and/or correction methods such as CRC (Cyclic Redundancy Code), EDC (Error Detection and Correction), parity or other encoding/decoding methods suited for this purpose. Further reliability enhancements may include operation re-try (to overcome intermittent faults such as those associated with the transfer of information), the use of one or more alternate or replacement communication paths and/or portions of such paths (e.g. “segments” of end-to-end “bitlanes”) between a given memory subsystem and the memory controller to replace failing paths and/or portions of paths, complement-re-complement techniques and/or alternate reliability enhancement methods as used in computer, communication and related systems.

The use of bus termination, on busses ranging from point-to-point links to complex multi-drop structures, is becoming more common consistent with increased performance demands. A wide variety of termination methods can be identified and/or considered, and include the use of such devices as resistors, capacitors, inductors or any combination thereof, with these devices connected between the signal line and a power supply voltage or ground, a termination voltage (such voltage directly sourced to the device(s) or indirectly sourced to the device(s) from a voltage divider, regulator or other means), or another signal. The termination device(s) may be part of a passive or active termination structure, and may reside in one or more positions along one or more of the signal lines, and/or as part of the transmitter and/or receiving device(s). The terminator may be selected to match the impedance of the transmission line, be selected as an alternate impedance to maximize the useable frequency, signal swings, data widths, reduce reflections and/or otherwise improve operating margins within the desired cost, space, power and other system/subsystem limits.

Technical effects include a memory hub device capable of interfacing with a variety of memory devices on a DIMM and/or with registers on RDIMMs providing efficient bus utilization in a memory system of a computer system. Using a narrow high-speed bus to interface with memory devices reduces the number of physical connections, which may reduce cost and power consumption. Supporting multiple ratios between the high-speed memory channel frequency and the memory device frequency can enable multiple memory device speeds to be supported and provide an upgrade path as higher speed memory devices become more affordable. Support for multiple independent memory ports, each with write data buffering, allows for bandwidth optimization. Buffering of data returning to the host (read data) may enable read commands to be issued at times when the channel returning to the host is busy so that the memory controller need not attempt to schedule read operations at precise times or leave unused bandwidth due to scheduling conflicts.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. Moreover, the use of the terms first, second, etc. do not denote any order or importance, but rather the terms first, second, etc. are used to distinguish one element from another.

What is clamed is:

1. A system comprising:
a memory controller;
a memory channel comprised of:
unidirectional downstream link segments including at least 13 data bit lanes, 2 spare bit lanes and a downstream clock, coupled to the memory controller and operable for transferring data frames configurable between 8, 12 and 16 transfers per frame, with each transfer comprised of multiple bit lanes; and
unidirectional upstream link segments including at least 20 bit lanes, 2 spare bit lanes and an upstream clock, coupled to the memory controller and operable for transferring data frames comprised of 8 transfers per frame, with each transfer comprised of multiple bit lanes;
a memory hub device coupled to the memory channel to communicate with the memory controller via one of a direct connection and a cascade interconnection through another memory hub device; and
multiple memory devices in communication with the memory controller via one or more cascade interconnected memory hub devices.

2. The system of claim 1 wherein a memory hub device interface to the memory devices includes a 2T memory addressing mode to hold memory command signals valid for two memory clock cycles and delay memory chip select signals by one memory clock cycle.

3. The system of claim 2 wherein the memory hub device interface to the memory devices further includes a variable driver impedance, slew rate and termination resistance for data input/output connections, and configurable data latencies.

4. The system of claim 1, further comprising 16 write data buffers, each 72-bits wide and 8-transfers deep to buffer write data in the one or more memory hub devices.

5. The system of claim 4 wherein the write data buffers are readable and writeable through a service interface independent of the upstream and downstream link segments.

6. The system of claim 1, further comprising 4 read data buffers, each 72-bits wide and 8-transfers deep to buffer read data in the one or more memory hub devices.

7. The system of claim 6 wherein the read data buffers are readable through a service interface independent of the upstream and downstream link segments.

8. The system of claim 1 wherein the one or more memory hub devices are operatively coupled to one or more of the memory devices via a direct connection and to one or more separate memory modules which further include address, command and control re-drive circuitry and clock re-alignment and re-drive circuitry.

9. The system of claim 8 wherein the one or more memory hub devices include support for industry standard registered dual inline memory module (RDIMM) parity and error signals.

10. A memory hub device comprising:
a link interface to communicate to one or more of a memory controller and another memory hub device via a memory channel, wherein the memory channel comprises:
unidirectional downstream link segments including at least 13 data bit lanes, 2 spare bit lanes and a downstream clock, coupled to the memory controller and operable for transferring data frames configurable between 8, 12 and 16 transfers per frame, with each transfer comprised of multiple bit lanes; and
unidirectional upstream link segments including at least 20 bit lanes, 2 spare bit lanes and an upstream clock, coupled to the memory controller and operable for transferring data frames comprised of 8 transfers per frame, with each transfer comprised of multiple bit lanes; and
a plurality of ports, wherein each port is configured to communicate to one of a memory device and a register device, wherein the register device includes address, command and control re-drive circuitry and clock re-alignment and re-drive circuitry to control access to one or more memory devices.

11. The memory hub device of claim 10 wherein the plurality of ports include a 2T memory addressing mode to hold memory command signals valid for two memory clock cycles and delay memory chip select signals by one memory clock cycle.

12. The memory hub device of claim 10 wherein each of the ports is configurable to interface with a combination of 1, 2, 4 or 8 ranks of dynamic random access memory (DRAM).

13. The memory hub device of claim 10 further comprising:
16 write data buffers, each 72-bits wide and 8-transfers deep to buffer write data; and
4 read data buffers, each 72-bits wide and 8-transfers deep to buffer read data.

14. The memory hub device of claim 12 further comprising a service interface independent of the link interface, wherein the write data buffers are readable and writeable through the service interface and the read data buffers are readable through the service interface.

15. The memory hub device of claim 10 wherein the ports further include variable driver impedance, slew rate and termination resistance for data input/output connections, and configurable data latencies.

16. A method for providing an enhanced cascade interconnected memory system, the method comprising:
configuring a memory hub device to communicate with a memory controller and multiple memory devices, wherein communication between the memory hub and the memory controller is established via a memory channel, the memory channel comprising:
unidirectional downstream link segments including at least 13 data bit lanes, 2 spare bit lanes and a downstream clock, coupled to the memory controller and operable for transferring data frames configurable between 8, 12 and 16 transfers per frame, with each transfer comprised of multiple bit lanes; and
unidirectional upstream link segments including at least 20 bit lanes, 2 spare bit lanes and an upstream clock, coupled to the memory controller and operable for transferring data frames comprised of 8 transfers per frame, with each transfer comprised of multiple bit lanes; and
configuring primary and secondary upstream and downstream transmitters and receivers of the memory hub device to communicate with the memory controller via the memory channel and one or more cascade interconnected memory hub devices.

17. The method of claim 16 wherein a memory hub device interface to the memory devices includes a 2T memory addressing mode to hold memory command signals valid for two memory clock cycles and delay memory chip select signals by one memory clock cycle.

18. The method of claim 16 further comprising
buffering write data in up to 16 write data buffers, each 72-bits wide and 8-transfers deep, wherein the write data buffers are readable and writeable through a service interface independent of the upstream and downstream link segments; and
buffering read data in up to 4 read data buffers, each 72-bits wide and 8-transfers deep, wherein the read data buffers are readable through the service interface.

19. The method of claim 16 wherein the one or more memory hub devices are operatively coupled to one or more of the memory devices via a direct connection and to one or more separate memory modules which further include address, command and control re-drive circuitry and clock re-alignment and re-drive circuitry.

20. The method of claim 16 wherein the one or more memory hub devices include support for industry standard registered dual inline memory module (RDIMM) parity and error signals.

21. A design structure tangibly embodied in a machine-readable medium for designing, manufacturing, or testing an integrated circuit, the design structure comprising:
a link interface to communicate to one or more of a memory controller and another memory hub device via a memory channel, wherein the memory channel comprises:
unidirectional downstream link segments including at least 13 data bit lanes, 2 spare bit lanes and a downstream clock, coupled to the memory controller and operable for transferring data frames configurable between 8, 12 and 16 transfers per frame, with each transfer comprised of multiple bit lanes; and
unidirectional upstream link segments including at least 20 bit lanes, 2 spare bit lanes and an upstream clock, coupled to the memory controller and operable for transferring data frames comprised of 8 transfers per frame, with each transfer comprised of multiple bit lanes; and
a plurality of ports, wherein each port is configured to communicate to one of a memory device and a register device, wherein the register device includes address, command and control re-drive circuitry and clock re-alignment and re-drive circuitry to control access to one or more memory devices.

22. The design structure of claim 21, wherein the design structure comprises a netlist.

23. The design structure of claim 21, wherein the design structure resides on storage medium as a data format used for the exchange of layout data of integrated circuits.

24. The design structure of claim 21, wherein the design structure resides in a programmable gate array.
